(19) United States
(12) Patent Application Publication
(10) Pub. No.: US 2026/0292771 A1
(43) Pub. Date: Sep. 24, 2026

(54) METHOD AND APPARATUS FOR INTER-UE COORDINATION AND SIDELINK POSITIONING IN COMMUNICATION SYSTEM

(71) Applicant: SAMSUNG ELECTRONICS CO., LTD., Suwon-si, Gyeonggi-do (KR)

(72) Inventors: Hyunsuk RYU, Suwon-si (KR); Cheolkyu SHIN, Suwon-si (KR); Kyoungmin PARK, Suwon-si (KR)

(21) Appl. No.: 19/474,153

(22) PCT Filed: Apr. 9, 2024
(86) PCT No.: PCT/KR2024/004689

§ 371 Date: Oct. 9, 2025

(30) Foreign Application Priority Data
Apr. 13, 2023 (KR) 10-2023-0049013

(51) Int. Cl. H04W 64/00; H04L 5/00; H04W 92/18

(52) U.S. Cl. CPC H04W 64/00; H04L 5/0048; H04W 92/18

(57) ABSTRACT

The present disclosure relates to a 5G or 6G communication system for supporting a higher data transmission rate. The present disclosure relates to a method and an apparatus for performing positioning. The method according to an embodiment of the present disclosure comprises the steps of: identifying configuration information related to a sidelink positioning method; transmitting sidelink control information (SCI); if a sidelink positioning reference signal (SL-PRS) is requested on the basis of a bit field included in the SCI, receiving the SL-PRS; on the basis of the SL-PRS, transmitting information regarding measurement corresponding to the sidelink positioning method; if the measurement corresponding to the sidelink positioning method is requested on the basis of the bit field included in the SCI, transmitting the SL-PRS; and after the transmission of the SL-PRS, receiving the information regarding the measurement corresponding to the sidelink positioning method.

### TECHNICAL FIELD

The disclosure relates to a wireless communication system and, more particularly, to a method and a device for performing positioning (location measurement).

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure relates to a wireless communication system and, particularly, to a method and a device for performing positioning (location measurement). Specifically, the disclosure proposes methods for performing positioning via a sidelink. However, it is noted that contents proposed in the disclosure are not limited to only sidelink.

The technical subjects pursued in various embodiments of the disclosure may not be limited to the above-mentioned matters, and other technical subjects which are not mentioned herein may be considered by those skilled in the art from the following description of various embodiments of the disclosure to be described below.

### Solution to Problem

A method performed by a terminal in a communication system according to an embodiment of the disclosure includes: identifying configuration information related to a sidelink positioning method; transmitting sidelink control information (SCI); when a sidelink positioning reference signal (SL-PRS) is requested based on a bit field included in the SCI, receiving the SL-PRS, and based on the SL-PRS, transmitting information on measurement corresponding to the sidelink positioning method; and when measurement corresponding to the sidelink positioning method is requested based on the bit field included in the SCI, transmitting the SL-PRS, and after transmission of the SL-PRS, receiving information on measurement corresponding to the sidelink positioning method.

According to an embodiment of the disclosure, when a size of the bit field is 2 bits: a first codepoint of the bit field indicates no-request for the SL-PRS and no-request for measurement corresponding to the sidelink positioning method; a second codepoint of the bit field indicates a request for the SL-PRS; a third codepoint of the bit field indicates a request for the SL-PRS and a request for measurement corresponding to the sidelink positioning method; and a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

According to an embodiment of the disclosure, when a size of the bit field is 1 bit: a first codepoint of the bit field indicates no-request for the SL-PRS and no-request for measurement corresponding to the sidelink positioning method; and a second codepoint of the bit field indicates a request for the SL-PRS or indicates a request for the SL-PRS and a request for measurement corresponding to the sidelink positioning method, according to a type of the sidelink positioning method.

According to an embodiment of the disclosure, when information on a resource related to the received SL-PRS among resources included in a sidelink resource pool is transmitted, a resource of the received SL-PRS is based on the resource related to the SL-PRS, and the resource related to the received SL-PRS is a resource preferred by the terminal or a resource not preferred by the terminal.

A terminal in a communication system according to an embodiment of the disclosure includes a transceiver, and a processor connected to the transceiver, wherein the processor is configured to: identify configuration information related to a sidelink positioning method; transmit sidelink control information (SCI); when a sidelink positioning reference signal (SL-PRS) is requested based on a bit field included in the SCI, receive the SL-PRS, and based on the SL-PRS, transmit information on measurement corresponding to the sidelink positioning method; and when measurement corresponding to the sidelink positioning method is requested based on the bit field included in the SCI, transmit the SL-PRS, and after transmission of the SL-PRS, receive information on measurement corresponding to the sidelink positioning method.

According to an embodiment of the disclosure, when a size of the bit field is 2 bits: a first codepoint of the bit field indicates no-request for the SL-PRS and no-request for measurement corresponding to the sidelink positioning method; a second codepoint of the bit field indicates a request for the SL-PRS; a third codepoint of the bit field indicates a request for the SL-PRS and a request for measurement corresponding to the sidelink positioning method; and a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

According to an embodiment of the disclosure, when a size of the bit field is 1 bit: a first codepoint of the bit field indicates no-request for the SL-PRS and no-request for measurement corresponding to the sidelink positioning method; and a second codepoint of the bit field indicates a request for the SL-PRS or indicates a request for the SL-PRS and a request for measurement corresponding to the sidelink positioning method, according to a type of the sidelink positioning method.

According to an embodiment of the disclosure, when information on a resource related to the received SL-PRS among resources included in a sidelink resource pool is transmitted, a resource of the received SL-PRS is based on the resource related to the SL-PRS, and the resource related to the received SL-PRS is a resource preferred by the terminal or a resource not preferred by the terminal.

A method performed by a terminal in a communication system according to an embodiment of the disclosure includes: identifying configuration information related to a sidelink positioning method; receiving sidelink control information (SCI); when a sidelink positioning reference signal (SL-PRS) is requested based on a bit field included in the SCI, transmitting the SL-PRS; and when measurement corresponding to the sidelink positioning method is requested based on the bit field included in the SCI, receiving the SL-PRS, and based on the SL-PRS, transmitting information on measurement corresponding to the sidelink positioning method.

According to an embodiment of the disclosure, when a size of the bit field is 2 bits: a first codepoint of the bit field indicates no-request for the SL-PRS and no-request for measurement corresponding to the sidelink positioning method; a second codepoint of the bit field indicates a request for the SL-PRS; a third codepoint of the bit field indicates a request for the SL-PRS and a request for measurement corresponding to the sidelink positioning method; and a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

According to an embodiment of the disclosure, when a size of the bit field is 1 bit: a first codepoint of the bit field indicates no-request for the SL-PRS and no-request for measurement corresponding to the sidelink positioning method; and a second codepoint of the bit field indicates a request for the SL-PRS or indicates a request for the SL-PRS and a request for measurement corresponding to the sidelink positioning method, according to a type of the sidelink positioning method.

According to an embodiment of the disclosure, when information on a resource related to the received SL-PRS among resources included in a sidelink resource pool is transmitted, a resource of the received SL-PRS is based on the resource related to the SL-PRS, and the resource related to the received SL-PRS is a resource preferred by the terminal or a resource not preferred by the terminal.

A terminal in a communication system according to an embodiment of the disclosure includes a transceiver, and a processor connected to the transceiver, wherein the processor is configured to: identify configuration information related to a sidelink positioning method; receive sidelink control information (SCI); when a sidelink positioning reference signal (SL-PRS) is requested based on a bit field included in the SCI, transmit the SL-PRS; and when measurement corresponding to the sidelink positioning method is requested based on the bit field included in the SCI, receive the SL-PRS, and based on the SL-PRS, transmit information on measurement corresponding to the sidelink positioning method.

According to an embodiment of the disclosure, when a size of the bit field is 2 bits: a first codepoint of the bit field indicates no-request for the SL-PRS and no-request for measurement corresponding to the sidelink positioning method; a second codepoint of the bit field indicates a request for the SL-PRS; a third codepoint of the bit field indicates a request for the SL-PRS and a request for measurement corresponding to the sidelink positioning method; and a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

According to an embodiment of the disclosure, when a size of the bit field is 1 bit: a first codepoint of the bit field indicates no-request for the SL-PRS and no-request for measurement corresponding to the sidelink positioning method; and a second codepoint of the bit field indicates a request for the SL-PRS or indicates a request for the SL-PRS and a request for measurement corresponding to the sidelink positioning method, according to a type of the sidelink positioning method.

The aforementioned various embodiments of the disclosure are merely some of preferred embodiments of the disclosure, and various embodiments reflecting technical features of the various embodiments of the disclosure may be derived and understood by those having ordinary skill in the art based on the detailed descriptions to be described below.

### Advantageous Effects of Invention

An embodiment of the disclosure proposes a method and a procedure for performing positioning (location measurement) by a terminal.

According to an embodiment of the disclosure, positioning can be performed more effectively.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a wireless communication system according to an embodiment of the disclosure.

FIG. 2 is a diagram illustrating an example of a communication method performed via a sidelink according to an embodiment of the disclosure.

FIG. 3 is a diagram for describing a resource pool used for sidelink transmission and reception according to an embodiment of the disclosure.

FIG. 4 is a diagram for describing an example of a case in which a location of a UE is calculated via a sidelink according to an embodiment of the disclosure.

FIG. 5 is a diagram for describing an example of a case in which a location of a UE is calculated via a sidelink according to an embodiment of the disclosure.

FIG. 6 is a diagram for describing an example of a case in which a location of a UE is calculated via a sidelink according to an embodiment of the disclosure.

FIG. 7 is a diagram for describing an example of a positioning method according to an embodiment of the disclosure,

FIG. 8 is a diagram for describing IUC during S-PRS transmission according to an embodiment of the disclosure.

FIG. 9 is a diagram for describing an example of a scheme 2 operation during S-PRS transmission according to an embodiment of the disclosure.

FIG. 10 is a diagram for describing scheme 2 sensing and resource selection operations based on a comb pattern of an S-PRS according to an embodiment of the disclosure.

FIG. 11 is a diagram for describing scheme 2 sensing and resource selection operations based on a time domain multiplexing (TDM) pattern of an S-PRS according to an embodiment of the disclosure.

FIG. 12 is a diagram for describing an S-PRS resource configuration method according to an embodiment of the disclosure.

FIG. 13 is a diagram illustrating an example of operations of a first UE and a second UE according to an embodiment of the disclosure.

FIG. 14 illustrates a structure of a UE according to an embodiment of the disclosure.

FIG. 15 illustrates a structure of a base station according to an embodiment of the disclosure.

FIG. 16 illustrates a structure of a location server according to an embodiment of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters.

The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

Furthermore, the “unit” in embodiments may include one or more processors.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3GPP standards (standards for 5G, NR, long-term evolution (LTE), or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

To meet the demand for wireless data traffic having increased since deployment of 4G communication systems, efforts have been made to develop an improved 5G communication system (new radio (NR)). The 5G communication system has been designed to support ultrahigh frequency (mmWave) bands (e.g., 28 GHz frequency bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems. Also, unlike in LTE, in the 5G communication systems, various subcarrier spacings including 15 kHz, 30 kHz, 60 kHz, and 120 KHz are supported, physical control channels use polar coding, and physical data channels use low density parity check (LDPC). Furthermore, as waveforms for uplink transmission, not only a CP-OFDM but also a DFT-S-OFDM are used.

While hybrid ARQ (HARQ) retransmission in units of transport blocks (TBs) are supported in LTE, HARQ retransmission based on a code block group (CBG) including a bundle of a plurality of code blocks (CBs) may be additionally supported in 5G.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology. As described above, a plurality of services may be provided to a user in a communication system, and in order to provide such a plurality of services to a user, a method for providing each service within the same time period according to the characteristics and an apparatus using the same are required. Various services provided in the 5G communication system are being studied, and one of the various services is a service that satisfies the requirements for low latency and high reliability. Furthermore, demands for mobile services are explosively increasing, and a location-based service (LBS) led by two requirements including an emergency service and a commercial application is rapidly developing. In particular, in the case of communication using sidelink, an NR sidelink system supports UE-to-UE unicast communication, groupcast (or multicast) communication, and broadcast communication. In addition, unlike LTE sidelink, which aims to transmit and receive basic safety information necessary for road driving of vehicles, the NR sidelink aims to provide more advanced services such as platooning, advanced driving, extended sensors, and remote driving.

In particular, in NR sidelink, positioning (location measurement) may be performed via a UE-to-UE sidelink. In other words, a method of measuring a location of a UE by using a positioning signal transmitted via a sidelink may be considered. An existing method of measuring a location of a UE by using positioning signals transmitted via a downlink and an uplink between the UE and a base station is possible only when the UE is within coverage of the base station.

However, when sidelink positioning is adopted, a location of a UE may be measured even when the UE is outside coverage of a base station. A positioning signal in a sidelink may be referred to as a sidelink positioning reference signal (S-PRS). However, it is noted that this may be replaced with another term. An embodiment of the disclosure proposes a method of requesting an S-PRS signal and a method of requesting a measurement result for the S-PRS, according to a positioning method supported in a sidelink. An embodiment of the disclosure proposes a method of requesting a positioning signal and a method of requesting a measurement result for the positioning signal in sidelink positioning.

Positioning methods considered in a sidelink may be based on sidelink round trip time (SL-RTT), sidelink reference signal time difference (SL-RSTD), sidelink relative time of arrival (SL-RTOA), and sidelink angle of arrival (SL-AoA), and the like. According to a corresponding positioning method, there may exist various cases, such as a case where a UE directly transmits an S-PRS signal, a case where a request for another UE to transmit an S-PRS signal is required, and/or a case of requesting a positioning measurement result another UE. Various cases may exist according to different positioning methods. The disclosure proposes an operation of a UE indicating such cases and an operation of a UE receiving such an indication, according to a positioning method.

In addition, the disclosure proposes a positioning method using inter-UE coordination (IUC) (cooperation between UEs) in a sidelink. In order to calculate (obtain) a coordinate position of a UE by using a positioning signal in a sidelink, S-PRS signals need to be received from multiple UEs. In addition, in this case, in order to guarantee accuracy of positioning measurement, the influence of interference between received S-PRS signals needs to be minimized.

Accordingly, the disclosure proposes a method in which a UE selects and indicates, via IUC, resources on which another neighboring UE is to transmit an S-PRS and/or a location at which the S-PRS is transmitted.

Based on at least one of the methods according to the disclosure, it may be possible to perform positioning in a sidelink. However, it is noted that the technology proposed in the disclosure is not limited to only sidelink. For example, the proposed positioning method may be applied to device-to-device (D2D) positioning. In addition, the proposed positioning method may also be applied to Uu positioning.

According to an embodiment of the disclosure, the scenarios described above may be supported. According to an embodiment of the disclosure, a method and a device for measuring a location (positioning) of a UE may be provided.

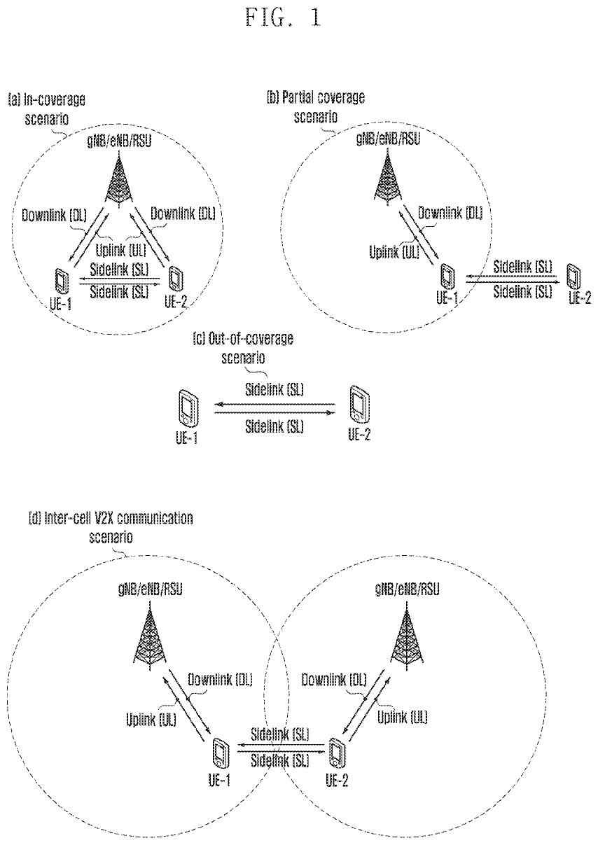

FIG. 1 is a diagram illustrating a communication system according to an embodiment of the disclosure.

Referring to FIG. 1, FIG. 1A illustrates an example of a case (in-coverage (IC)) in which both UEs (e.g., UE-1 and UE-2) communicating via a sidelink are located within coverage of a base station. Both UEs may receive data and control information from a base station via a downlink (DL), or transmit data and control information to the base station via an uplink (UL). In this case, the data and control information may be data and control information for sidelink communication. The data and control information may also be data and control information for general cellular communication. In addition, the UEs may transmit/receive data and control information for corresponding communication via a sidelink (SL).

Referring to FIG. 1B, illustrated is an example of a case in which, among UEs (e.g., UE-1 and UE-2), UE-1 is located within coverage of a base station and UE-2 is located outside coverage of the base station. That is, FIG. 1B illustrates an example of partial coverage (PC) in which one (UE-2) of the UEs is located outside the coverage of the base station. The UE (UE-1) located within the coverage of the base station may receive data and control information from the base station via a downlink or transmit data and control information to the base station via an uplink. The UE (UE-2) located outside the coverage of the base station cannot receive data and control information from the base station via a downlink and cannot transmit data and control information to the base station via an uplink.

The UE (UE-2) may transmit/receive data and control information for corresponding communication (e.g., sidelink communication) to/from the UE (UE-1) via a sidelink.

Referring to FIG. 1C, illustrated is an example of a case in which both UEs (e.g., UE-1 and UE-2) are located outside coverage of a base station (out-of-coverage (OOC)). Therefore, the UEs (UE-1 and UE-2) cannot receive data and control information from the base station via a downlink, and cannot transmit data and control information to the base station via an uplink. The UEs (UE-1 and UE-2) may transmit/receive data and control information via a sidelink.

Referring to FIG. 1D, FIG. 1D illustrates an example of a scenario in which side communication is performed between UEs (UE-1 and UE-2) located in different cells. Specifically, FIG. 1D illustrates a case in which the UEs (UE-1 and UE-2) are connected to (a radio resource control (RRC) disconnected state (RRC_CONNECTED)) or camped on (RRC disconnected state, i.e., RRC_IDLE or RRC_INACTIVE state) different base stations. In this case, the UE (UE-1) may be a transmission UE in the sidelink, and the UE (UE-2) may be a reception UE in the sidelink. Alternatively, the UE (UE-1) may be a reception UE in the sidelink, and the UE (UE-2) may be a transmission UE in the sidelink. The UE (UE-1) may receive a system information block (SIB) from a base station to which the UE (UE-1) is connected (or on which the UE (UE-1) is camping), and the UE (UE-2) may receive an SIB from another base station to which the V2X UE (UE-2) is connected (or on which the UE (UE-2) is camping). In this case, as the SIB, an existing SIB may be used, or an SIB defined separately for sidelink communication may be used. In addition, information of the SIB received by the UE (UE-1) and information of the SIB received by the UE (UE-2) may be different from each other. Therefore, in order for sidelink communication to be performed between the UEs (UE-1 and UE-2) located in different cells, either information may need to be unified, or the information may be signaled so that a method of interpreting SIB information transmitted from respective different cells may be additionally required.

For convenience of description, FIG. 1 illustrates the sidelink system including two UEs (UE-1 and UE-2). However, the disclosure is not limited thereto, and communication may be performed among more UEs.

An interface (e.g., an uplink and a downlink) between a base station and UEs may be referred to as a Uu interface, and sidelink communication between UEs may be referred to as a PC5 interface. Therefore, in the disclosure, these may be used interchangeably.

In the disclosure, a UE may refer to a general UE and/or a UE that supports vehicle-to-everything (V2X). For example, in the disclosure, a UE may refer to a handset (e.g., a smartphone) of a pedestrian. Alternatively, in the disclosure, a UE may include a vehicle that supports vehicle-to-vehicle (V2V) communication, a vehicle that supports vehicle-to-pedestrian (V2P) communication, a vehicle that supports vehicle-to-network (V2N) communication, or a vehicle that supports communication between a vehicle and transportation infrastructure (vehicle-to-infrastructure, (V2I)). Alternatively, in the disclosure, a UE may include a road side unit (RSU) equipped with UE functions, an RSU equipped with base station functions, or an RSU equipped with some of base station functions and some of UE functions.

According to an embodiment of the disclosure, a base station may be a base station that supports both V2X communication and general cellular communication, or a base station that supports only V2X communication. In this case, the base station may be a 5G base station (gNB), a 4G base station (eNB), or an RSU.

Accordingly, in the disclosure, a base station may be referred to as an RSU.

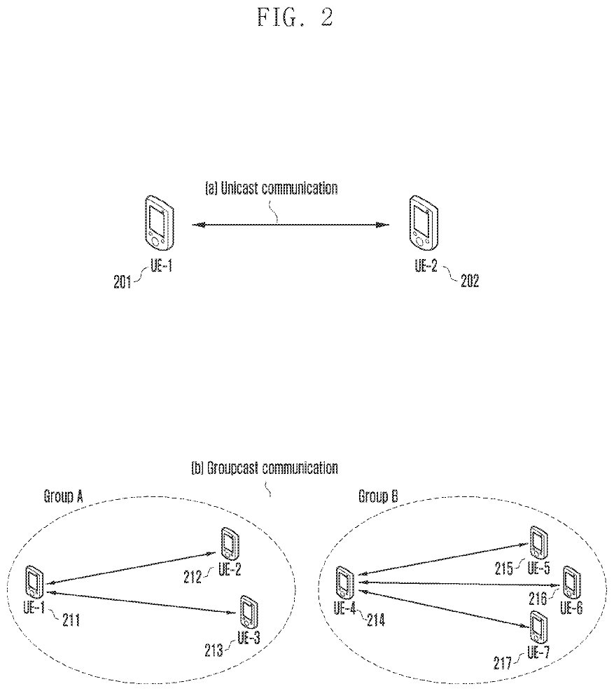

FIG. 2 is a diagram illustrating an example of a communication method performed via a sidelink according to an embodiment of the disclosure.

Referring to FIG. 2A, UE-1 201 (e.g., a TX UE) and UE-2 202 (e.g., an RX UE) may perform one-to-one communication, and this may be referred to as unicast communication. In a sidelink, capability information and configuration information may be exchanged between the UEs via PC5-RRC defined for a UE-to-UE unicast link. In addition, configuration information may be exchanged via a sidelink medium access control (MAC) control element (CE) defined for the UE-to-UE unicast link. Configuration information may include destination ID and/or source ID information.

In the disclosure, a method of exchanging information for unicast is not limited to the PC5-RRC and MAC-CE-based methods. For example, relevant information may be included in SCI (1st SCI or 2nd SCI). Alternatively, some of the information may be included in the SCI and transmitted, while the remaining part may be included in another channel and transmitted via PC5-RRC or MAC-CE.

Referring to FIG. 2B, a TX UE and an RX UE may perform one-to-many (one-to-multi) communication, and this may be referred to as groupcast or multicast. In FIG. 2B, UE-1 211, UE-2 212, and UE-3 213 may form one group (group A) to perform groupcast communication, and UE-4 214, UE-5 215, UE-6 216, and UE-7 217 may form another group (group B) to perform groupcast communication.

Each UE may perform groupcast communication within a group to which each UE itself belongs, and communication between different groups may be performed via unicast, groupcast, or broadcast communication. For convenience of description, FIG. 2B illustrates a case in which two groups (group A and group B) are formed, but the disclosure is not limited thereto.

Although not illustrated in FIG. 2, the UEs may perform broadcast communication in a sidelink. Broadcast communication refers to a case in which data and control information transmitted by a transmission UE via a sidelink are received by all other UEs (e.g., UEs performing sidelink communication). For example, when it is assumed in FIG. 2B that UE-1 211 is a transmission UE for broadcast, all the UEs (UE-2 212, UE-3 213, UE-4 214, UE-5 215, UE-6 216, and UE-7 217) may receive data and control information transmitted by UE-1 211.

In NR V2X, unlike in LTE V2X, supporting a form in which a vehicle UE transmits data to only one specific node via unicast and a form in which data is transmitted to specific multiple nodes via groupcast may be considered. For example, these unicast and groupcast technologies may be useful in a service scenario such as platooning that is a technology of connecting two or more vehicles via a single network and moving the vehicles in a group form. For example, unicast communication may be required for controlling one specific node by a leader node of a group connected via platooning, and groupcast communication may be required for simultaneously controlling a group including specific multiple nodes.

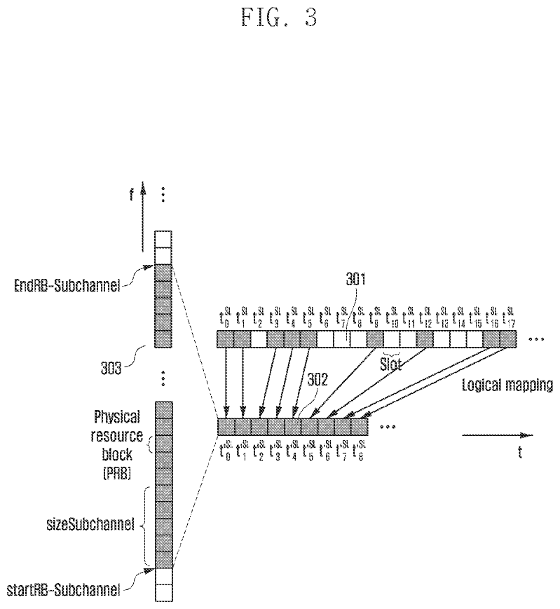

FIG. 3 is a diagram for describing a resource pool used for sidelink transmission and reception according to an embodiment of the disclosure.

Referring to FIG. 3, a resource pool may be defined as a set of resources in time and frequency. In a resource pool, a resource allocation unit (resource granularity) on the time axis may be a slot. In addition, the resource allocation unit on the frequency axis of the resource pool may be a sub-channel including one or more physical resource blocks (PRBs). In the disclosure, although a description is provided for an example of a case in which a resource pool is discontinuously allocated in time, the disclosure is not limited thereto, and, for example, a resource pool may be allocated continuously in time. Also, in the disclosure, although a description is provided for an example of a case in which a resource pool is continuously allocated in frequency, the disclosure is not limited thereto, and the disclosure is not excluded from being applied to a method in which a resource pool is discontinuously allocated in frequency.

Referring to FIG. 3, a case 301 in which a resource pool is discontinuously allocated in time is illustrated. FIG. 3 illustrates a case in which resource granularity in time is configured by slots. A sidelink slot may be defined within a slot used for uplink. For example, a length of a symbol used for sidelink within one slot may be configured as sidelink bandwidth part (BWP) information.

Therefore, among slots used for uplink, slots in which a length of a symbol configured for sidelink is not guaranteed cannot be sidelink slots. In addition, slots in which a sidelink synchronization signal block (S-SSB) is transmitted are excluded from slots belonging to the resource pool. Referring to 301, except for such slots (slots that cannot be used for sidelink), a set of slots (t₀^{SL}, t₁^{SL}, t₂^{SL}, . . . ) that may be used for sidelink in time is illustrated. Shaded parts in 301 indicate sidelink slots belonging to the resource pool. Unshaded parts in 301 indicate sidelink slots not belonging to the resource pool. The sidelink slots belonging to the resource pool may be (pre-)configured with resource pool information via a bitmap. Referring to 302, a set of sidelink slots (t′₀^{SL}, t′₁^{SL}, t′₂^{SL}, . . . ) belonging to the resource pool in time is illustrated.

In the disclosure, (pre-)configuration may refer to configuration information pre-configured for a UE and stored in advance, and/or refer to a case in which a UE is configured in a cell-common manner by a base station. Here, cell-common may indicate that UEs within a cell receive configuration of the same information from a base station. In this case, a method in which a UE acquires cell-common information by receiving a sidelink system information block (SL-SIB) from a base station may be considered.

Alternatively, (pre-)configuration may also refer to a case in which a UE is configured in a UE-specific manner after an RRC connection to a base station is established. Here, UE-specific may be replaced with the term “UE-dedicated”, and may indicate that configuration information (configuration information of a specific value) is received as a specific value for each UE. This may also indicate that a UE receives UE-specific configuration information. In this case, a method in which a UE acquires UE-specific information by receiving an RRC message from a base station may be considered.

Alternatively, as a (pre-)configuration method, a method of configuration with resource pool information and a method of configuration not in resource pool information may be considered. That is, (pre-)configuration may or may not be based on resource pool information. When resource pool information is (pre-)configured (when (pre-)configuration is a method of configuration in resource pool information), all UEs operating in a corresponding resource pool may operate with common configuration information, except for a case in which a UE is configured in a UE-specific manner after an RRC connection to a base station is established. The method of (pre-)configuration not in resource pool information is basically a method in which configuration is performed independently of resource pool configuration information. For example, one or more modes (e.g., A, B, and C) may be (pre-)configured in a resource pool, and via information (pre-)configured independently of resource pool configuration information, a mode (e.g., A, B, or C) to be used may be indicated from among the modes (pre-)configured in the resource pool.

In addition, in sidelink unicast transmission, (pre-)configuration may also be configured via PC5-RRC. Alternatively, a method of (pre-)configuration performed via MAC-CE may also be considered.

For the term “(pre-)configuration” in the disclosure, it is noted that at least one of the cases described above may be applied.

Referring to 303 in FIG. 3, a case in which a resource pool is allocated contiguously in frequency is illustrated. On the frequency axis, resource allocation may be configured with sidelink bandwidth part (BWP) information, and may be performed in units of sub-channels. A sub-channel may be defined as a resource granularity in frequency, which includes one or more physical resource blocks (PRBs). That is, a sub-channel may be defined to have an integer (or natural number) multiple of a PRB. Referring to 303, for example, a sub-channel may include five consecutive PRBs, and a sub-channel size (sizeSubchannel) may be a size of five consecutive PRBs. However, the content illustrated in FIG. 3 is merely an example of the disclosure, and a size of a sub-channel may be configured differently. It is common that one sub-channel includes consecutive PRBs, but one sub-channel is not necessarily required to include consecutive PRBs. For example, there may be a sub-channel including non-consecutive PRBs. A sub-channel may be a basic resource granularity for a PSSCH. In 303, startRB-Subchannel may indicate a start location of a sub-channel in frequency in a resource pool. When resource allocation is performed in units of sub-channels on the frequency axis, resources in frequency may be allocated via configuration information on a resource block (RB) index (startRB-Subchannel) at which the sub-channel starts, information (sizeSubchannel) on the number of PRBs constituting the sub-channel, a total number of sub-channels (numSubchannel), and the like. Information on startRB-Subchannel, sizeSubchannel, and numSubchannel may be (pre-)configured with resource pool information in frequency.

One of methods of allocating a transmission resource in a sidelink may include a method of receiving allocation of a sidelink transmission resource from a base station when a UE is within coverage of the base station. Hereinafter, this method is referred to as mode 1. In other words, mode 1 may indicate a method in which a base station allocates resources, which are used for sidelink transmission, to RRC-connected UEs in a dedicated scheduling scheme. The method of mode 1 may be effective for interference management and resource pool management because a base station is able to manage sidelink resources.

In contrast, the methods of allocating a transmission resource in a sidelink may include a method in which a UE directly allocates a transmission resource via sensing in a sidelink. Hereinafter, this method may be referred to as mode 2. Mode 2 may also be referred to as UE autonomous resource selection. Unlike mode 1 in which a base station directly participates in resource allocation, mode 2 allows a transmission UE to autonomously select resources via a sensing and resource selection procedure defined based on a (pre-)configured resource pool, and to transmit data via the selected resource. Subsequently, when transmission resource allocation is performed via mode 1 or mode 2, the UE may transmit/receive data and control information via a sidelink. Here, the control information may include sidelink control information (SCI) format 1-A as 1^{st} stage SCI transmitted via a physical sidelink control channel (PSCCH). In addition, the control information may include at least one of SCI format 2-A or SCI format 2-B as 2^{nd} stage SCI transmitted via a physical sidelink shared channel (PSSCH),

Hereinafter, a method using positioning signals (e.g., positioning reference signals (PRSs)) transmitted via a downlink and an uplink of a UE and a base station is described as a positioning method of measuring a location of a UE. In the disclosure, a method using positioning signals transmitted via a downlink and an uplink of a UE and a base station may be referred to as radio access technology (RAT)-dependent positioning. In addition, other positioning methods may be classified as RAT-independent positioning. As an example, for an LTE system, methods, such as observed time difference of arrival (OTDOA), uplink time difference of arrival (UTDOA), and enhanced cell identification (E-CID), may be used as an RAT-dependent positioning technique. For an NR system, methods, such as downlink time difference of arrival (DL-TDOA), downlink angle-of-departure (DL-AOD), multi-round trip time (multi-RTT), NR E-CID, uplink time difference of arrival (UL-TDOA), and uplink angle-of-arrival (UL-AOA), may be used. In contrast, an RAT-independent positioning technique may include methods involving, such as assisted global navigation satellite systems (A-GNSS), sensors, wireless local area network (WLAN), and Bluetooth. The positioning methods to which the disclosure is applicable are not limited to the examples described above.

In the disclosure, an embodiment of an RAT-dependent positioning method supported via sidelink is described. However, this is for convenience of description, and the disclosure is not limited to only sidelink and RAT-dependent positioning.

For an interface (e.g., uplink and downlink, hereinafter, referred to as Uu) between a base station and UEs, RAT-dependent positioning may be possible only when a UE is within coverage of the base station. However, it is noted that RAT-dependent positioning for sidelink may not be limited to a case in which a UE is within coverage of a base station. For RAT-dependent positioning in Uu, positioning protocols, such as an LTE positioning protocol (LPP), an LTE positioning protocol annex (LPPa), and an NR positioning protocol annex (NRPPa), may be used.

LPP may be regarded as a positioning protocol defined between a UE and a location server (LS). LPPa and NRPPa may be regarded as positioning protocols defined between a base station and a location server. Here, the location server is an entity managing location measurement, and may perform functions of a location management function (LMF). In addition, the location server may also be referred to as LMF or another name.

For LTE and NR systems, both systems support LPP, and the following roles for positioning may be performed via LPP.
Positioning capability exchange
Assistance data transmission
Location information transmission
Error processing
Abort

It is noted that a UE and a location server may perform the above roles via LPP, a base station may serve to enable the UE and the location server to exchange positioning information. In this case, exchanging of the positioning information via LPP may be performed transparently to the base station. This may indicate that the base station is not involved in exchanging of the positioning information between the UE and the location server.

In exchanging of positioning capability, positioning information supportable by the UE may be exchanged with the location server. For example, the positioning information supportable by the UE may include whether a positioning method supported by the UE is a UE-assisted method or a UE-based method, or whether both of the methods are supportable.

The UE-assisted method refers to a scheme of, without the UE directly measuring an absolute position of the UE, transferring a measurement value for an applied positioning technique to the location server, based on a received positioning signal, wherein the absolute position of the UE is calculated in the location server. For example, the absolute position may indicate two-dimensional (x,y) and three-dimensional (x,y,z) coordinate position information of the UE according to longitude and latitude. In contrast, the UE-based method may be a scheme in which the UE directly measures an absolute position of the UE, and to this end, while receiving a positioning signal, the UE may also need to receive location information of an entity that transmits the positioning signal.

In the LTE system, only the UE-assisted scheme is supported, whereas both UE-assisted and UE-based positioning may be supported in the NR system.

When measuring an accurate location of the UE, transmission of assistance data may be a very important element in positioning. Specifically, in assistance data transmission, the location server may provide the UE with configuration information for a positioning signal, and at least one of information on a candidate cell to receive the positioning signal (a candidate cell to which the positioning signal is to be transmitted), a transmission reception point (TRP), and/or the like.

For example, when DL-TDOA is used, the information on the candidate cell to receive the positioning signal (the candidate cell to which the positioning signal is to be transmitted) and the TRP may include one or more of information on a reference cell, a reference TRP, a neighbor cell, neighbor TRP, and/or the like.

In addition, multiple candidates for the neighbor cell and neighbor TRP may be provided, and information on a cell and a TRP, which the UE should select to measure the positioning signal, may also be provided.

In order for the UE to measure an accurate location, candidate cell and TRP information serving as a reference need to be properly selected. For example, the accuracy of positioning measurement may be increased when a channel for a positioning signal received from a corresponding candidate cell and TRP is a line-of-sight (LOS) channel, in other words, a channel having fewer non-LOS (NLOS) channel components. Therefore, when the location server provides the UB with candidate cell and TRP information, which serve as references for performing positioning, by collecting various information, the UE may perform more accurate positioning measurement.

Location information transmission may be performed via LPP. The location server may request location information from the UE, and the UE may provide the location server with the measured location information in response to the request.

For the UE-assisted method, the location information may be or may include a measurement value for the positioning technique based on the received positioning signal. In contrast, for the UE-based method, the location information may be or may include two-dimensional (x,y) and three-dimensional (x,y,z) coordinate position values of the UE.

When requesting the location information from the UE, the location server may make the request including a required accuracy, response time, and the like as information on a positioning quality of service (QoS). For example, the location server may transmit location request information to the UE, the request information may include positioning QoS information, and the positioning QoS information may include one or more of required accuracy and response time.

When the positioning QoS information is requested, the UE needs to provide the location server with location information measured to satisfy the accuracy and response time. If it is impossible to satisfy the QoS, the UE may consider error handling and abort. However, this is merely an example, and error handling and abort for positioning may be performed in a case other than a case where it is impossible to satisfy the QoS.

The positioning protocol defined between the base station and the location server may be referred to as LPPa in the LTE system, and the following functions may be performed between the base station and the location server.
E-CID location information transmission
OTDOA information transmission
General error state reporting
Assistance data transmission

The positioning protocol defined between the base station and the location server may be referred to as NRPPa in the NR system, and in addition to the above functions performed by LPPa, the following functions may be additionally performed between the base station and the location server.
Positioning information transmission
Measurement information transmission
TRP information transmission

Unlike the LTE system, the NR system supports more positioning techniques. Therefore, via the positioning information transmission, various positioning techniques may be supported. For example, it is possible for the base station to perform positioning measurement based on a positioning sounding reference signal (SRS) transmitted by the UE. Therefore, information related to positioning SRS configuration and activation/deactivation may be exchanged as the positioning information between the base station and the location server, Measurement information transmission indicates a function of exchanging, between the base station and the location server, information related to multi-RTT, UL-TDOA, and UL-AOA which are not supported in the LTE system.

TRP information transmission indicates a function of exchanging information related to performing TRP-based positioning. Although cell-based positioning has been performed in the LTE system, TRP-based positioning may be performed in the NR system, so that information related to performing TRP-based positioning may be exchanged.

In sidelink, an entity that performs positioning-related configuration to measure a location of a UE and an entity that calculates positioning may be classified into three cases as follows.
UE (no LS)
LS (through BS)
LS (through UE)

In the above, the LS refers to a location server, the BS refers to a base station, such as gNB or eNB, and the UE refers to a UE that performs transmission and reception via a sidelink. As described above, the UE that performs transmission and reception via a sidelink may include a vehicle UE and a pedestrian UE. In addition, the UE that performs transmission and reception via a sidelink may include a road side unit (RSU) equipped with UE functions, an RSU equipped with base station functions, or an RSU equipped with some of the base station functions and some of the UE functions. In addition, the UE that performs transmission and reception via a sidelink may include a positioning reference unit (PRU) having a known location thereof.

The UE (no LS) refers to a sidelink UE having no connection to a location server. The LS (through BS) is a location server and may refer to a location server connected to a base station. In contrast, the LS (through UE) is a location server and may refer to a location server connected to a sidelink UE. In other words, the LS (through UE) may indicate a case in which a location server is available even when a UE is not within coverage of a base station. In this case, the LS (through UE) may be available only for a specific UE, such as an RSU or a PRU, other than a general UE. In addition, a UE connected to a location server in a sidelink may be defined as a new UE (a new type of device). In addition, only a specific UE supporting a UE capability of connecting to a location server may perform a function of connecting to a location server via a sidelink.

In Table 1, cases 1 to 9 indicate various combinations according to an entity that performs positioning-related configuration and an entity that calculates positioning in order to measure a location of a UE in a sidelink.

TABLE 1

| | Positioning configuration | Positioning calculation |
|---|---|---|
| Case 1 | UE (no LS) | UE (no LS) |
| Case 2 | UE (no LS) | LS (through BS) |
| Case 3 | UE (no LS) | LS (through UE) |
| Case 4 | LS (through BS) | UE (no LS) |
| Case 5 | LS (through BS) | LS (through BS) |
| Case 6 | LS (through BS) | LS (through UE) |
| Case 7 | LS (through UE) | UE (no LS) |
| Case 8 | LS (through UE) | LS (through BS) |
| Case 9 | LS (through UE) | LS (through UE) |

In the disclosure, a UE for which location measurement is required is referred to as a target UE. In addition, a UE which has a known location thereof or is able to provide a positioning signal for location measurement of a target UE may be referred to as an anchor UE.

The anchor UE may transmit a positioning signal (e.g., a sidelink positioning reference signal (PRS)) to the target UE. For example, the anchor UE may have its own location information and may provide UE location information (e.g., the location information of the anchor UE) together with a sidelink positioning reference signal (S-PRS). In other words, the anchor UE may be a UE the location of which is already known (known location). If the anchor UE is a UE the location of which is already known (known location), the location information may be transferred to the target UE, and the target UE may perform UE-based positioning. On the contrary, the anchor UE may be a UE having an unknown location. For example, in this case, ranging-based positioning may be performed.

It is noted in the disclosure that, the terms “target UE” and “anchor UE” may be replaced with other terms. For example, the anchor UE may be referred to as a positioning reference (PosRef) UE. Alternatively, the anchor UE may be an RSU or a PRU.

Positioning configuration may be classified into a UE-configured scheme and a network-configured scheme. Here, the UE-configured scheme refers to a case in which a UE performs positioning configuration, and the network-configured scheme refers to a case in which positioning configuration is performed via a network.

Specifically, in Table 1, positioning configuration of UE (no LS) may correspond to the UE-configured scheme. The UE-configured scheme is advantageous in that positioning configuration is possible even when a UE is not within coverage of a network (base station).

In Table 1, positioning configuration of LS (through BS) may correspond to the network-configured scheme. The network-configured scheme indicates a case in which a UE is within network coverage, and since positioning calculation and measurement information are reported to the base station, and location measurement of a target UE is performed by the location server connected to the base station, a delay may occur due to signaling related to the location measurement, but more accurate location measurement may be possible.

In Table 1, since positioning configuration of LS (through UE) is not a scheme in which a UE is configured via the base station within network coverage, the positioning configuration may not be classified as the network-configured scheme.

In addition, although a location server connected to the UB provides a configuration, if the configuration is not classified as being configured by the UE, the configuration may not be classified as the UE-configured scheme. However, if the configuration is classified as being configured by the UE, the configuration may be classified as the UE-configured scheme. Therefore, the case of LS (through UE) may be referred to as a scheme other than the UE-configured or the network-configured scheme.

In addition, positioning calculation may be classified into two schemes that are a UE-assisted scheme and a UE-based scheme, as described above. In Table 1, positioning calculation of UE (no LS) may correspond to the UE-based scheme, and positioning calculation of LS (through BS) or LS (through UE) may generally correspond to the UE-assisted scheme. However, when position calculation is LS (through UE), and a corresponding location server is interpreted as a UE, the LS (through UE) may also be classified as the UE-based scheme.

In Table 1, positioning configuration information may include sidelink positioning reference signal (S-PRS) configuration information. The S-PRS configuration information may be or may include pattern information and/or information on a time/frequency transmission position of S-PRS. In addition, in positioning calculation of Table 1, a UE may receive an S-PRS, measurement may be performed from the received S-PRS, and a method of positioning measurement and calculation may vary according to a positioning method that is applied. For example, location information measurement or positioning in a sidelink may be absolute positioning that provides two-dimensional (x,y) and three-dimensional (x,y,z) coordinate position values of a UE, and may be relative positioning that provides relative two-dimensional or three-dimensional position information from another UE. In addition, location information in a sidelink may include ranging information including one or both of a distance and a direction from another UE.

If ranging in sidelink includes both distance and direction information, the ranging may have the same meaning as relative positioning. In addition, methods based on, such as sidelink time difference of arrival (SL-TDOA), sidelink angle-of-departure (SL-AOD), sidelink multi-round trip time (SL multi-RTT), sidelink round trip time (SL RTT), sidelink E-CID, and sidelink angle-of-arrival (SL-AOA), may be considered as positioning methods, and the disclosure is not limited thereto,

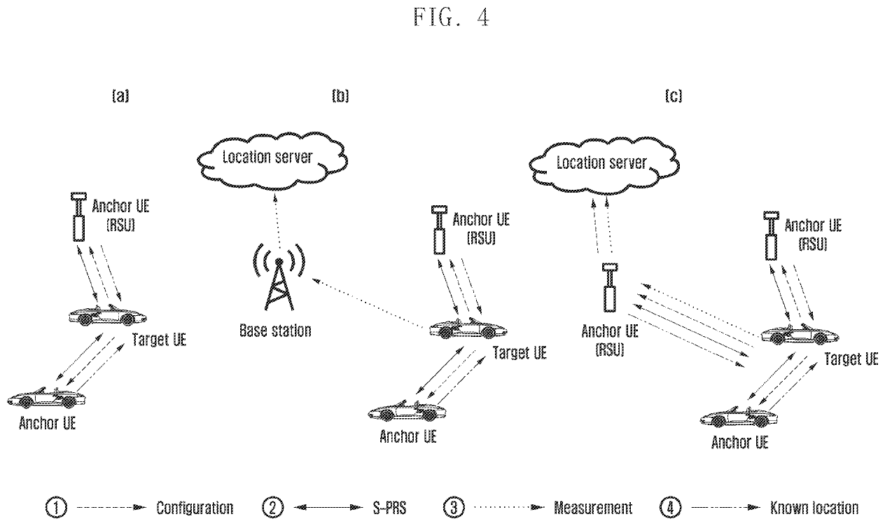

FIGS. 4 to 6 are diagrams for describing an example of a case in which a location of a UE is calculated via a sidelink according to an embodiment of the disclosure.

However, a case of calculating a location of a UE via a sidelink in the disclosure is not limited to the cases illustrated in FIGS. 4 to 6.

In FIGS. 4 to 6, signaling of positioning configuration information is illustrated by line 1. S-PRS transmission is illustrated by line 2. It is noted that S-PRS transmission may be performed in either a bidirectional or a unidirectional manner. Transmission of measured information or measured positioning information for positioning is illustrated by line 3. Transmission of location information known to a UE or known location information is illustrated by line 4.

FIG. 4A illustrates an example of a case in which a sidelink UE not connected to a location server provides a positioning configuration, and a target UE not connected to a location server performs positioning calculation. This may correspond to case 1 of Table 1. In this case, the target UE may broadcast, unicast, or groupcast an indication on positioning-related configuration information to another UE via a sidelink. In addition, the target UE may perform positioning calculation based on a received positioning signal.

FIG. 4B illustrates an example of a case in which a sidelink UE not connected to a location server provides a positioning configuration, a target UE is located within network coverage, and the location server connected to a base station performs positioning calculation. This may correspond to case 2 of Table 1. In this case, the target UE may broadcast, unicast, or groupcast an indication on positioning-related configuration information to another UE via a sidelink. In addition, the target UE may perform positioning measurement based on a received positioning signal. Since the target UE is within base station coverage, the target UE may report measured positioning information to the base station. Then, the measurement information is reported to the location server connected to the base station, and the location server may perform positioning calculation.

FIG. 4C illustrates an example of a case in which a sidelink UE not connected to a location server provides a positioning configuration, and the location server performs positioning calculation via a sidelink UE connected to the location server. This may correspond to case 3 of Table 1. In this case, the target UE may broadcast, unicast, or groupcast an indication on positioning-related configuration information to another UE via a sidelink. In addition, the target UE may perform positioning measurement based on a received positioning signal. Since the target UE is within sidelink coverage of the UE connected to the location server, the target UE may report measured positioning information to the UE connected to the location server. In FIG. 4C, the UE connected to the location server is illustrated as an anchor UE (RSU), but it is noted that the UE connected to the location server may be a UE other than the RSU. Thereafter, the measurement information is reported to the location server connected to the anchor UE (RSU), and the location server may perform positioning calculation.

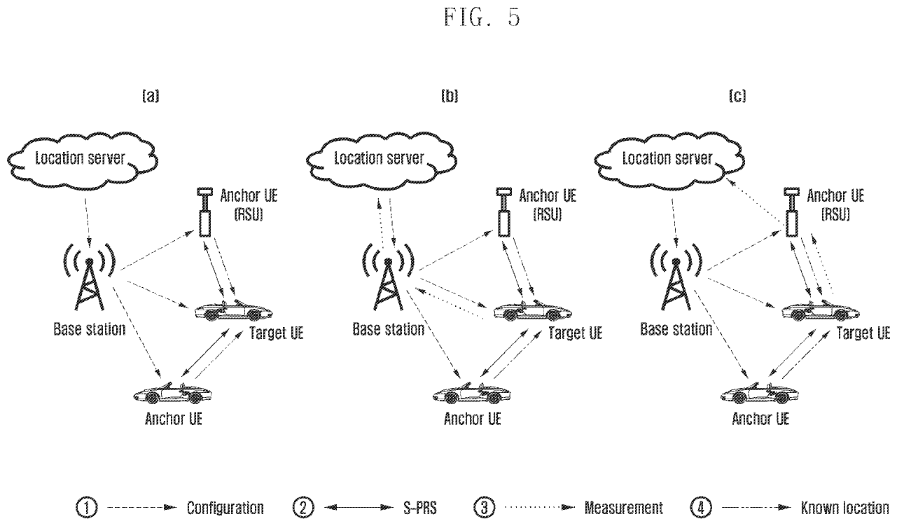

FIG. 5A illustrates an example of a case in which a sidelink UE is located within network coverage, a location server connected to a base station provides a positioning configuration, and a target UE not connected to the location server performs positioning calculation. This may correspond to case 4 of Table 1. In this case, the location server connected to the base station may provide positioning configuration information by using a positioning protocol such as LPP. In addition, the target UE may perform positioning calculation based on the received configuration information and a positioning signal.

FIG. 5B illustrates an example of a case in which a sidelink UE is located within network coverage, a location server connected to a base station provides a positioning configuration, a target UE is located within the network coverage, and the location server connected to the base station performs positioning calculation.

This may correspond to case 5 of Table 1. In this case, the location server connected to the base station may provide positioning configuration information by using a positioning protocol such as LPP. In addition, the target UB may perform positioning calculation based on the received configuration information and a positioning signal. Since the target UE is within base station coverage, the target UE may report measured positioning information to the base station. Then, the measurement information is reported to the location server connected to the base station, and the location server may perform positioning calculation.

FIG. 5C illustrates an example of a case in which a sidelink UE is located within network coverage, a location server connected to a base station provides a positioning configuration, and the location server performs positioning calculation via a sidelink UE connected to the location server. This may correspond to case 6 of Table 1. In this case, the location server connected to the base station may provide positioning configuration information by using a positioning protocol such as LPP. In addition, the target UE may perform positioning calculation based on the received configuration information and a positioning signal. Since the target UE is within sidelink coverage of the UE connected to the location server, the target UE may report measured positioning information to the UE connected to the location server. In FIG. 5C, the UE connected to the location server is illustrated as an anchor UE (RSU), but it is noted that the UE connected to the location server may be a UE other than the RSU. Thereafter, the measurement information is reported to the location server connected to the anchor UE (RSU), and the location server may perform positioning calculation.

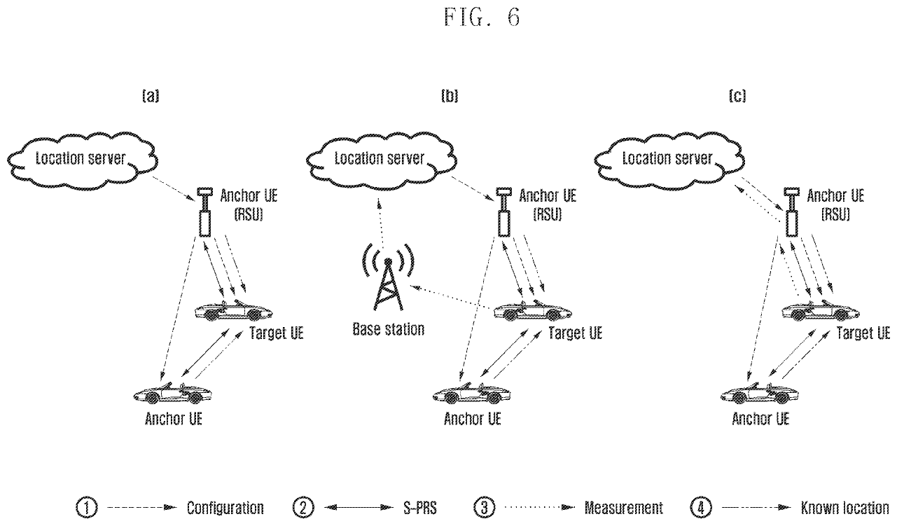

FIG. 6A illustrates an example of a case in which a location server provides a positioning configuration via a sidelink UE connected to the location server, and a target UE not connected to the location server performs positioning calculation.

This may correspond to case 7 of Table 1. In this case, the location server connected to the UE may provide positioning configuration information by using a positioning protocol such as LPP. In addition, the target UE may perform positioning calculation based on the received configuration information and a positioning signal.

FIG. 6B illustrates an example of a case in which a location server provides a positioning configuration via a sidelink UE connected to the location server, a target UE is located within network coverage, and the location server connected to a base station performs positioning calculation. This may correspond to case 8 of Table 1. In this case, the location server connected to the UE may provide positioning configuration information by using a positioning protocol such as LPP.

In addition, the target UE may perform positioning calculation based on the received configuration information and a positioning signal. Since the target UE is within base station coverage, the target UE may report measured positioning information to the base station. Then, the measurement information is reported to the location server connected to the base station, and the location server may perform positioning calculation.

FIG. 6C illustrates an example of a case in which a location server provides a positioning configuration via a sidelink UE connected to the location server, and the location server performs positioning calculation via the sidelink UE connected to the location server. This may correspond to case 9 of Table 1. In this case, the location server connected to the UE may provide positioning configuration information by using a positioning protocol such as LPP. In addition, the target UE may perform positioning calculation based on the received configuration information and a positioning signal. Since the target UE is within sidelink coverage of the UE connected to the location server, the target UB may report measured positioning information to the UE connected to the location server. In FIG. 6C, the UE connected to the location server is illustrated as an anchor UE (RSU), but it is noted that the UE connected to the location server may be a UE other than the RSU. Thereafter, the measurement information is reported to the location server connected to the anchor UE (RSU), and the location server may perform positioning calculation.

Positioning configuration may be performed when a request for positioning, for example, a location service request, is generated. It has been described in Table 1 that an entity performing positioning configuration may be a UE (no LS), an LS (through BS), or an LS (through UE). Here, the LS (through UE) indicates a case in which a location server is installed in or connected to a UE, and may be referred to as a server UE. It is noted that, in the disclosure, a UE which may serve as a server UE is not limited to a specific UE. For example, a target UE may be a server UE, or an anchor UE may be a server UE. Alternatively, a UE that is neither a target UE nor an anchor UE may be a server UE. Here, it is noted that the “server UE” may be replaced with another term having a similar meaning.

The entity performing positioning configuration may determine a target UE and anchor UE(s) performing sidelink positioning. When absolute positioning is performed, multiple UEs may be determined as anchor UE candidates.

Positioning performance may vary according to which UE among the multiple candidates is determined as the anchor UE to perform positioning. The entity performing positioning configuration may discover, via a discovery procedure, a target UE and anchor UE(s) capable of performing sidelink positioning. In the disclosure, the procedure in which the entity performing positioning configuration performs discovery is not limited to a specific method. The entity performing positioning configuration may discover a target UE and anchor UE(s), and may trigger the UEs to transmit a positioning signal or cause the UEs to report a positioning measurement result. Here, the positioning signal may be a sidelink positioning reference signal (S-PRS).

The disclosure proposes an operation of a UB which, according to a positioning method supported in a sidelink, triggers transmission of a positioning signal or requests a positioning measurement result, and an operation of a UE that has received such an indication.

The following embodiments describe a method of performing sidelink positioning using an S-PRS transmitted via a sidelink.

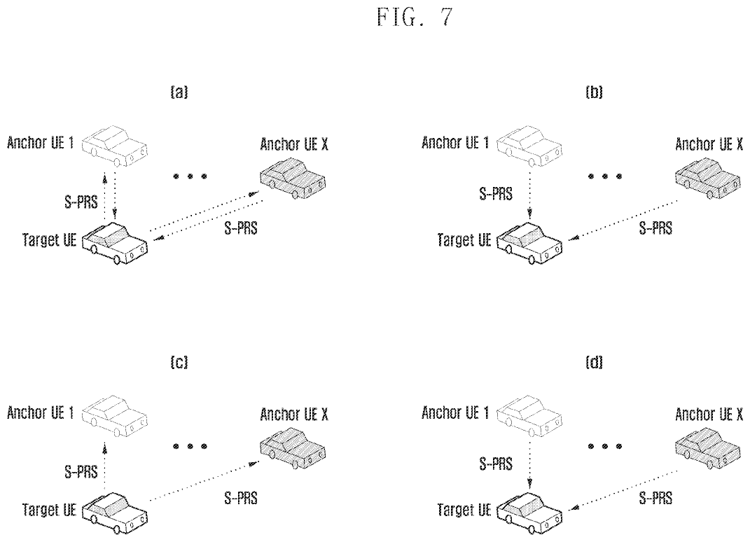

FIG. 7 is a diagram for describing an example of a positioning method according to an embodiment of the disclosure. FIG. 7 illustrates sidelink round trip time (SL-RTT), sidelink reference signal time difference (SL-RSTD), sidelink relative time of arrival (SL-RTOA), and sidelink angle of arrival (SL-AoA), but the sidelink positioning method of the disclosure is not limited thereto.

Referring to FIG. 7, it is noted that an entity performing positioning configuration is not illustrated. An entity performing positioning configuration is not limited to a specific entity, and, for example, as described with reference to Table 1, a UE (no LS), an LS (through BS), or an LS (through UE) may be an entity performing positioning configuration. In the above, the LS (through UE) is referred to as a server UE, and it has been described that the server UE may be a target UE, another anchor UE, or a UE that is neither the target UE nor the anchor UE. The server UE may be a road side unit (RSU) and a UE.

FIG. 7A illustrates an example of a method in which a sidelink round trip time (SL-RTT) is measured using an S-PRS transmitted via a sidelink.

Referring to FIG. 7A, for SL-RTT measurement of a target UE, an S-PRS is transmitted to a neighboring anchor UE. In this case, triggering of S-PRS transmission of the target UE may be performed by the target UE itself (e.g., UE (no LS)), a location server (e.g., LS (through BS)) connected to a BS, or a server UE (e.g., LS (through UE)). In order for the target UE to perform SL-RTT measurement, the anchor UE(s) need to receive the S-PRS transmitted by the target UE, and transmit an S-PRS to the target UE. In addition, the anchor UE(s) need to report a time difference (i.e., an Rx-Tx time difference) between reception of the S-PRS transmitted by the target UE and transmission of the S-PRS to the target UE. Triggering of S-PRS transmission from the anchor UE(s) to the target UE and requesting reporting of the Rx-Tx time difference may be performed by the target UE itself (i.e., UE (no LS)), the location server (i.e., LS (through BS)) connected to the BS, or the server UE (i.e., LS (through UE)). Hereinafter, embodiment 1 considers a case in which triggering of S-PRS transmission from the anchor UE(s) to the target UE and requesting reporting of the Rx-Tx time difference are performed by the target UE. In this case, the target UE may be the server UE (i.e., LS (through UE)) and/or a UE (i.e., UE (no LS)) not connected to the location server.

FIG. 7B illustrates an example of a method in which a sidelink reference signal time difference (SL-RSTD) is measured using an S-PRS transmitted via a sidelink.

Referring to FIG. 7B, for SL-RSTD measurement of a target UE, neighboring anchor UE(s) transmit an S-PRS to the target UE. In this case, triggering of S-PRS transmission of the anchor UE(s) may be performed by the target UE itself (e.g., UE (no LS)), a location server (e.g., LS (through BS)) connected to a BS, or a server UE (e.g., LS (through UE)). Hereinafter, embodiment 1 considers a case in which triggering of S-PRS transmission of the anchor UE(s) is performed by the target UE. In this case, the target UE may be the server UE (i.e., LS (through UE)) and/or a UE (i.e., UE (no LS)) not connected to the location server. For example, SL-TDOA may be performed based on SL-RSTD.

FIG. 7C illustrates an example of a method in which a sidelink relative time of arrival (SL-RTOA) is measured using an S-PRS transmitted via a sidelink.

Referring to FIG. 7C, for positioning of a target UE, the target UE may transmit an S-PRS to a neighboring anchor UE. In this case, triggering of S-PRS transmission of the target UE may be performed by the target UE itself (e.g., UE (no LS)), a location server (e.g., LS (through BS)) connected to a BS, or a server UE (e.g., LS (through UE)). For positioning of the target UE, the anchor UE(s) may need to receive the S-PRS transmitted by the target UE, measure an RTOA, and report the RTOA to the target UE. Requesting the anchor UE(s) to report the RTOA to the target UE may be performed by the target UE itself (i.e., UE (no LS)), the location server connected to the BS (i.e., LS (through BS)), or the server UE (i.e., LS (through UE)). Hereinafter, embodiment 1 considers a case in which triggering of S-PRS transmission from the anchor UE(s) to the target UE and requesting reporting of the Rx-Tx time difference are performed by the target UE.

In this case, the target UE may be the server UE (i.e., LS (through UE)) and/or a UE (i.e., UE (no LS)) not connected to the location server. For example, SL-TDOA may be performed based on SL-RTOA.

FIG. 7D illustrates an example of a method in which a sidelink angle of arrival (SL-AoA) is measured using an S-PRS transmitted via a sidelink.

Referring to FIG. 7D, for SL-AoA measurement of a target UE, neighboring anchor UE(s) transmit an S-PRS to the target UE. In this case, triggering of S-PRS transmission of the anchor UE(s) may be performed by the target UE itself (e.g., UE (no LS)), a location server (e.g., LS (through BS)) connected to a BS, or a server UE (e.g., LS (through UE)). Hereinafter, embodiment 1 considers a case in which triggering of S-PRS transmission of the anchor UE(s) is performed by the target UE. In this case, the target UE may be the server UE (i.e., LS (through UE)) and/or a UE (i.e., UE (no LS)) not connected to the location server.

It is noted that at least one or a combination of at least one of the embodiments below may be used.

### First Embodiment

The first embodiment proposes an operation of a UE which, according to a positioning method supported in a sidelink, triggers transmission of a positioning signal or requests a positioning measurement result.

For example, referring to FIG. 7, a case is considered in which triggering of S-PRS transmission from the anchor UE(s) to the target UE and requesting reporting of a positioning measurement result (e.g., Rx-Tx time difference or RTOA) are performed by the target UE. In this case, the target UE may be the server UE (i.e., LS (through UE)) and/or a UE (i.e., UE (no LS)) not connected to the location server.

The target UE may trigger the anchor UE(s) to perform S-PRS transmission and may request the anchor UE(s) to report a positioning measurement result (e.g., Rx-Tx time difference or RTOA), via higher-layer signaling and/or lower-layer signaling.

For example, as a method via a higher layer (or a method via a higher-layer signal), a method using a sidelink MAC-CE or PC5-RRC and/or a method by signaling via a sidelink positioning protocol (SLPP) may be considered. Here, the SLPP is a positioning protocol, such as the LPP described above, and may be used by a server UE to transmit and receive positioning-related information to and from another UE.

For example, as a method via a lower layer (or a method via a lower-layer signal), an indication method using sidelink control information (SCI) may be considered.

When two-stage SCI is considered, a method of including the information in 1^{st} SCI transferred through a physical sidelink control channel (PSCCH) may be considered. Additionally/alternatively, a method of including the information in 2^{nd} SCI transferred through a physical sidelink shared channel (PSSCH) may also be considered. Alternatively, when single-stage SCI is considered, a method of including the information in SCI transferred through a physical sidelink control channel (PSCCH) may be considered.

According to the positioning methods described in FIG. 7, the methods being based on sidelink round trip time (RTT), sidelink reference signal time difference (SL-RSTD), sidelink relative time of arrival (SL-RTOA), and sidelink angle of arrival (SL-AoA), information requested by the target UE from the anchor UE(s) may vary, as follows, according to the positioning methods.
SL-RTT: S-PRS transmission, and positioning measurement result (i.e., Rx-Tx time difference)
SL-RSTD: S-PRS transmission
SL-RTOA: S-PRS transmission, and positioning measurement result (i.e., RTOA)
SL-AoA: S-PRS transmission

Therefore, according to the first method proposed in the embodiment, indication information for a request made by the target UE to the anchor UE(s) may be determined according to a configured and determined positioning method. For example, the target UE may use a 1-bit field to indicate, via the aforementioned higher-layer signal and lower-layer signal, a case of making a request to the anchor UE(s) and a case of not making a request to the anchor UE(s). When requested by the target UE, information on the request may be interpreted as triggering and requesting of the information according to a configured and determined positioning method.

Here, configuration and determination of the positioning method may be performed in various ways. In addition, the following methods may be considered in the disclosure. One or more of the following methods may be supported, or one or more methods may be combined and used. It is also noted that the methods presented below are merely exemplary, and the disclosure is not limited thereto.
Method 1: The server UE (i.e., LS (through UE)) determines a positioning method and indicates the same to the target UE and the anchor UE(s).
Method 2: The location server connected to the BS (i.e., LS (through BS)) determines a positioning method and indicates the same to the target UE and the anchor UE(s).
Method 3: The UE (i.e., UE (no LS)) not connected to the location server determines a positioning method and indicates the same to the target UE and the anchor UE(s).
Method 4: A positioning method is (pre-)configured for a resource pool. In this case, one or more positioning methods may be selected and configured. If one or more methods are selected and configured, one positioning method may be determined via methods 1 to 3 described above.

According to the second method proposed in the embodiment, regardless of a positioning method, the target UE may use a 2-bit field to make a request to the anchor UE(s) via the aforementioned higher-layer signal and/or lower-layer signal.

For example, as shown in Table 2 below, the request information may be included in the higher-layer signal and/or lower-layer signal.

TABLE 2

| | |
|---|---|
| 00 | No request/triggering |
| 01 | Triggering S-PRS |
| 10 | Request measurement report |
| 11 | both triggering S-PRS triggering and request measurement report |

Referring to Table 2, each case may be indicated according to a value of the 2-bit field. A value “00” of the 2-bit field may correspond/map to a case in which no request is made for S-PRS triggering or for reporting of a positioning measurement result (e.g., Rx-Tx time difference or RTOA). A value “01” of the 2-bit field may correspond/map to S-PRS triggering. A value “10” of the 2-bit field may correspond/map to requesting reporting of positioning measurement. A value “11” of the 2-bit field may correspond/map to S-PRS triggering and requesting reporting of positioning measurement.

According to the third method proposed in the embodiment, when a positioning method is (pre-)configured for a resource pool, and one or more methods are selected and configured, the target UE may use, according to the configured positioning method(s), the 1- or 2-bit bit field to make a request to the anchor UE(s) via the aforementioned higher-layer signal and/or lower-layer signal. It is noted that, in the disclosure, when one or more positioning methods are (pre-)configured, a method of finally determining a positioning method is not limited to a specific method. For example, the server UE may determine the positioning method.

Alternatively, when the UE is within base station coverage, the location server connected to the base station may determine the positioning method. In contrast, a method in which the target UE determines the positioning method may also be considered.

For example, when three or all four of the positioning methods based on SL-RTT, SL-RSTD, SL-RTOA, and SL-AoA are configured for a resource pool, the corresponding information may be requested via Table 2. That is, when all of the SL-RTT, SL-RSTD, SL-RTOA, and SL-AoA are (pre-)configured for a resource pool, or when three of the SL-RTT, SL-RSTD, SL-RTOA, and SL-AoA are (pre-)configured for a resource pool, the corresponding information may be requested via Table 2.

For example, when two methods are configured (e.g., when two methods are configured for a resource pool), the following combinations may be possible as the positioning methods.
SL-RTT, SL-RSTD
SL-RTT, SL-AoA
SL-RSTD, SL-RTOA
SL-RTOA, SL-AoA

In this case, Table 2 above or Table 3 below may be used, and the corresponding request information may be included in a 2-bit field in a higher-layer signal and/or a lower-layer signal.

TABLE 3

| | |
|---|---|
| 00 | No request/triggering |
| 01 | Triggering S-PRS |
| 10 | both triggering S-PRS triggering and request measurement report |
| 11 | reserved |

For example, when two methods are configured (e.g., when two methods are configured for a resource pool), the following combinations may be possible as the positioning methods.
SL-RTT, SL-RTOA

In this case, Table 4 below may be used, and the corresponding request information may be included in a 1-bit field in a higher-layer signal and/or a lower-layer signal.

TABLE 4

| | |
|---|---|
| 00 | No request/triggering |
| 01 | both triggering S-PRS triggering and request measurement report |

For example, when two methods are configured (e.g., when two methods are configured for a resource pool), the following combinations may be possible as the positioning methods.
SL-RSTD, SL-AoA

In this case, Table 5 below may be used, and the corresponding request information may be included in a 1-bit field in a higher-layer signal and/or a lower-layer signal.

TABLE 5

| | |
|---|---|
| 00 | No request/triggering |
| 01 | Triggering S-PRS |

Finally, when one method is configured (e.g., when one method is configured for a resource pool), the target UE may use a 1-bit field to indicate, via the aforementioned higher-layer signal and lower-layer signal, a case of making a request to the anchor UE(s) and a case of not making a request to the anchor UE(s).

When requested by the target UE, information on the request may be interpreted as triggering and requesting of the following information. That is, interpretation of the 1-bit field may vary according to a positioning method configured for a positioning resource pool.
SL-RTT: S-PRS transmission, and positioning measurement result (i.e., Rx-Tx time difference)
SL-RSTD; S-PRS transmission
SL-RTOA: S-PRS transmission, and positioning measurement result (i.e., RTOA)
SL-AoA: S-PRS transmission

According to the fourth method proposed in the embodiment, for a UE having received an S-PRS, S-PRS triggering may be automatically performed, or reporting of a positioning measurement result may be automatically requested.

For the UE having received an S-PRS, S-PRS transmission may be triggered, and/or reporting of a positioning measurement result may be requested. For example, automatic S-PRS triggering may correspond to all the positioning methods. In contrast, reporting of a positioning measurement result may be a case in which a positioning method is SL-RTT or a case in which a positioning method is configured and determined as SL-RTOA. Configuration and determination of the positioning method may refer to the methods presented above.

### Second Embodiment

The second embodiment proposes an operation of a UE for which positioning signal triggering is performed or reporting of a positioning measurement result is requested.

In the first embodiment, when the target UE triggers the anchor UE(s) to transmit an S-PRS, the anchor UE(s) may need to determine sidelink transmission resources for S-PRS transmission. For example, S-PRS transmission resources may be selected directly by the anchor UE(s) via sensing or may be randomly selected.

Alternatively, another UE may select resources for S-PRS transmission for the anchor UE(s), and provide corresponding resource information. This may be referred to as inter-UE coordination. For details of inter-UE coordination during the S-PRS transmission, a reference may be made to a third embodiment.

In the first embodiment, when the target UE requests the anchor UE(s) to report a positioning measurement result (e.g., Rx-Tx time difference or RTOA), the anchor UE(s) may need to determine resources for reporting a positioning measurement result. A positioning measurement result may be reported through a PSSCH.

For example, PSSCH resources for reporting of a positioning measurement result may be selected directly by the anchor UE(s) via sensing or may be randomly selected. Alternatively, another UE may select resources for S-PRS transmission for the anchor UE(s), and provide corresponding resource information. This may be referred to as inter-UE coordination.

The S-PRS may be transmitted in a resource pool (which may be referred to as a shared resource pool with SL communication) in which SL data is transmitted, or may be transmitted in a resource pool (which may be referred to as a dedicated resource pool for SL positioning) defined for S-PRS. When reporting of a positioning measurement result (e.g., Rx-Tx time difference or RTOA) is performed through a PSSCH, the result may be transmitted in a resource pool in which SL data is transmitted. If the PSSCH is defined in the resource pool defined for S-PRS, the positioning measurement result may also be reported in the corresponding resource pool. A method in which the positioning measurement result is transmitted as data information via the PSSCH may be considered, and/or a method in which corresponding information is included in 2^{nd} SCI and transmitted via the PSSCH may be considered.

In addition, a method may be considered in which a single 2^{nd} SCI format is supported when S-PRS triggering and/or requesting of a positioning measurement result are indicated via 2^{nd} SCI, and additionally, the positioning measurement result is provided via the 2^{nd} SCI. That is, the 2^{nd} SCI used for S-PRS triggering and/or requesting of a positioning measurement result and used for reporting of the positioning measurement result may be a single predefined/configured format. This may be a method for reducing the number of supported 2^{nd} SCI formats. In addition, 1-bit information may be included in the 2^{nd} SCI format, and whether the current 2^{nd} SCI format is used for S-PRS triggering and/or requesting of a positioning measurement result, or is used for reporting of a positioning measurement result may be indicated via the 1-bit information. The total number of required bits may differ between a case where the 2^{nd} SCI format, in which the method above is used, is indicated as being used for requesting and a case where the 2^{nd} SCI format is indicated as being used for reporting. Accordingly, the total number of bits of the 2^{nd} SCI format may be determined in consideration of a case requiring a larger number of bits. That is, the number of bits required when the 2^{nd} SCI format is used for S-PRS triggering and/or requesting of a positioning measurement result, and the number of bits required when the 2^{nd} SCI format is used for reporting of a positioning measurement result may be different, and in this case, a larger number of required bits may be considered. For example, when a smaller number of bits is required, zero bits may be padded to equalize the number of bits in both cases.

### Third Embodiment

The third embodiment proposes a procedure for inter-UE coordination (IUC) during S-PRS transmission.

In order to calculate a coordinate position of a UE by using a positioning signal in a sidelink, S-PRS signals need to be received from multiple UEs. In addition, in this case, in order to guarantee accuracy of positioning measurement, the influence of interference between received S-PRS signals may need to be minimized.

Accordingly, the disclosure proposes a method in which a UE selects and indicates, via IUC, resources on which another neighboring UE is to transmit an S-PRS and/or a location at which the S-PRS is transmitted.

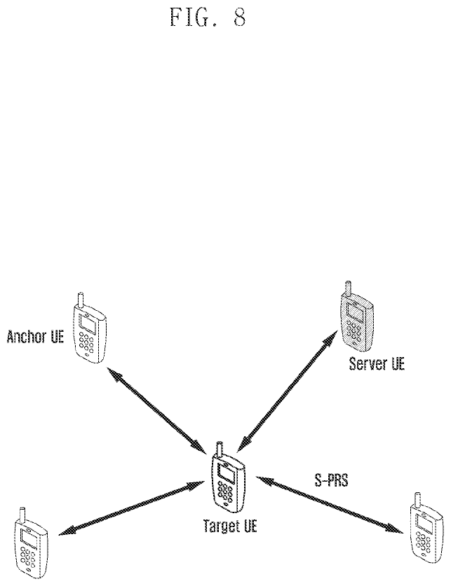

FIG. 8 is a diagram for describing IUC during S-PRS transmission according to an embodiment of the disclosure.

Referring to FIG. 8, three types of UEs are illustrated as an example. A target UE refers to a UE for which location measurement is required. An anchor UE refers to a UE that may provide a positioning signal for location measurement of a target UE. For example, for an anchor UE, a location of the UE may be known.

A server UE is an LS (through UE), and may be defined as a UE in which a location server has been installed and/or to which the location server has been connected.

As described above, it is noted that, in the disclosure, a UE which may serve as a server UE is not limited to a specific UE. For example, a target UE may be a server UE, or an anchor UE may be a server UE. Alternatively, a UE that is neither a target UE nor an anchor UE may be a server UE.

A server UE may receive a request for a location service, via a sidelink positioning protocol (SLPP). The request for a location service may be a request for sidelink positioning. The server UE that has received the request may serve as an entity performing positioning configuration, and may discover, via a discovery procedure, a target UE and anchor UE(s) capable of performing sidelink positioning. In the disclosure, the procedure of performing discovery by the server UE is not limited to a specific method. The server UE may discover a target UE and anchor UE(s), and may trigger the UEs to transmit a positioning signal or cause the UEs to report a positioning measurement result. Here, the positioning signal may be a sidelink positioning reference signal (S-PRS).

In addition, the server UE may discover a target UE and anchor UE(s), and trigger IUC for the UE(s). In general, during S-PRS transmission, a UE that transmits an S-PRS may allocate resources for S-PRS transmission by sensing and resource selection, and may perform S-PRS transmission in the allocated resources. In contrast, IUC may refer to a method in which, via sensing and resource selection, a UE other than a UE transmitting an S-PRS provides resource allocation information for S-PRS transmission, to the UE transmitting an S-PRS. In IUC, a UE other than a UE transmitting an S-PRS selects/determines resources for S-PRS transmission via sensing and resource selection, and provides resource allocation information therefor (or IUC information including the same) to the UE transmitting an S-PRS, and the UE having received the resource allocation information may transmit an S-PRS via the resources identified from the resource allocation information. The sensing and resource selection method for IUC and the operation of the UE having received the information may refer to the fourth embodiment below.

It is noted that a UE performing IUC is not limited to a specific UE in the disclosure. For example, the UE performing IUC may be a server UE, an anchor UE, or a target UE. Alternatively, the UE performing IUC may be a UE other than any of a server UE, a target UE, and an anchor UB. The UE performing IUC may be, for example, a UE that provides IUC information.

For example, when considering a case in which a UE that receives an S-PRS and performs positioning measurement is a target UE, the target UE may perform IUC and provide IUC information to anchor UE(s). Therefore, provision of IUC information to the anchor UE(s) by the target UE during S-PRS transmission may be triggered under the following conditions. That is, when one or more of the following conditions are satisfied, the target UE may provide IUC information to the anchor UE(s).
Condition 1: a case in which the server UE makes a request to the target UE. For example, the request may be made via SLPP. In this case, the request information may be signaled via a sidelink MAC-CE and PC5-RRC.
Condition 2: a case in which the anchor UE makes a request to the target UE. For example, the request may be made via higher-layer and lower-layer signaling. For example, when higher-layer signaling is used, the request information may be signaled via a sidelink MAC-CE and PC5-RRC. For example, when lower-layer signaling is used, the request information may be signaled via SCI (1^{st} SCI or 2^{nd} SCI for 2-stage SCI).
Condition 3: by internal triggering (i.e., an internal cause) of the target UE, for example, a case in which the internal cause is satisfied.

The presented conditions are illustrative, and the disclosure is not limited only to the presented conditions. In addition, one or more of the presented conditions may be supported, or may be combined and used. When one or more of the conditions are supported, the conditions used may be (pre-)configured.

In addition, the UE may provide one or more pieces of the following information as IUC information.
Information 1: time and frequency resource information for S-PRS transmission
Information 2: comb size information and comb offset information for an S-PRS pattern

The presented information is illustrative, and the disclosure is not limited to the presented IUC information. In addition, only some of the presented IUC information may be used. For example, at least some of time resource information for S-PRS transmission, frequency resource information for S-PRS transmission, comb size information for an S-PRS pattern, or comb offset information for an S-PRS pattern may be provided as IUC information. The presented IUC information may be provided via higher-layer and/or lower-layer signaling. For example, when higher-layer signaling is used, corresponding request information may be signaled via a sidelink MAC-CE and PC5-RRC. The higher-layer signaling may be signaling via SLPP. For example, when lower-layer signaling is used, corresponding request information may be signaled via SCI (1^{st} SCI or 2^{nd} SCI for 2-stage SCI). A method of indicating information 1 and information 2 is described in more detail via the following embodiment.

### Fourth Embodiment

The fourth embodiment proposes a sensing and resource selection method for inter-UE coordination (IUC) of a UE during S-PRS transmission. In addition, an operation of a UE having received corresponding information is proposed.

In sidelink positioning, resource selection for S-PRS transmission may be divided into a method in which corresponding resources are allocated by a base station (hereinafter, referred to as scheme 1), and a method in which a UE directly selects resources via sensing (hereinafter referred to as scheme 2). For scheme 2, a UE operation needs to be defined, and may be performed according to the following procedure. However, the resource selection method for S-PRS transmission in the disclosure is not limited to the following procedure. The scheme 2 operation presented below is described on the assumption of an operation for IUC, but is not limited thereto. For example, the presented operation may also be applied to a case in which a UE transmitting an S-PRS directly performs the scheme 2 operation.

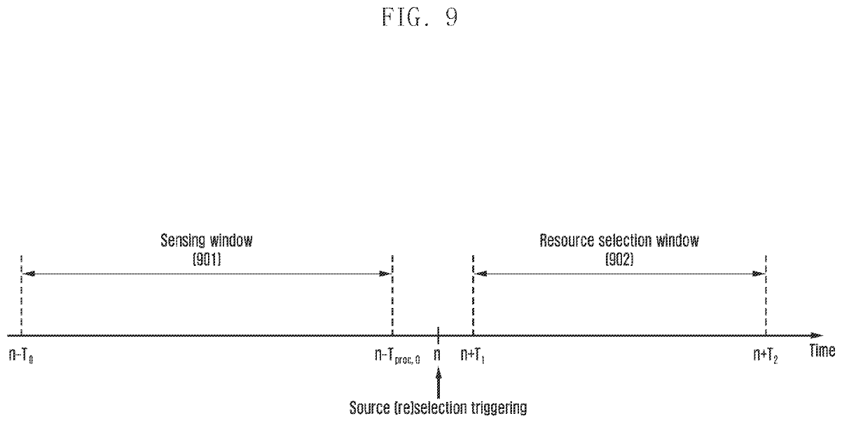

FIG. 9 is a diagram for describing an example of a scheme 2 operation during S-PRS transmission according to an embodiment of the disclosure.

Referring to FIG. 9, with respect to time point n at which resource (re) selection is triggered, a sensing window 901 from n-T0 to n-Tproc,0 may be defined/configured, and a resource selection window 902 from n+T1 to n+T2 may be defined/configured. In the sensing window 901, a value of T0 may be (pre-)configured. In the disclosure, a value of TO is not limited to a specific value. In addition, Tproc,0 is a time required to process a sensing result, and may be determined to be a different value according to subcarrier spacing (SCS). As SCI becomes larger, more slots may need to be allocated for Tproc,0. In the disclosure, a value of Tproc,0 is not limited to a specific value. In the selection window 902, a value of T1 may be selected by UE implementation for T1≤Tproc,1. Tproc,1 is a time required to select resources, and may be determined to be a different value according to SCS. As SCI becomes larger, more slots may need to be allocated for Tproc,1. In addition, a UE selects T2 within a range T2≤remaining packet delay budget (PDB) by considering the remaining PDB. In addition, the UE selects T2 within a range satisfying T2≥T2 min. If T2 min>remaining PDB, then T2 min=remaining PDB. Here, T2 min may serve to prevent the UE from selecting an excessively small value of T2. Here, T2 min may be defined as a function of a priority of a transmission UE. The priority of the transmission UE may be information indicated by SCI. In addition, a value of T2 min, “T2min(priority)”, based on the priority may be configured in a higher layer.
The UE performs sensing in the sensing window 901. Performing sensing may be defined as an operation of decoding sidelink control information (SCI) transmitted by another UE and performing reference signal received power (RSRP) measurement. The SCI may include resource allocation information. The UE determines, via the SCI decoding, whether resources of a candidate resource area (resource selection window 902), which the UE itself is to use for transmission, are occupied by another UE, and if occupied, the amount of interference is identified via the RSRP measurement. Here, the RSRP may indicate an RSRP measured via an S-PRS. Through the sensing, the UE may select final N candidate resources. Here, the N candidate resources may be selected via sensing in units of subchannels and slots. Here, the units of subchannels, in which sensing and resource selection are performed, may be determined by a higher layer of the UE. During the selection of the N candidate resources, the RSRP measurement and a priority of an S-PRS may be used together. For example, the SCI may include S-PRS priority information. In addition, the priority of the S-PRS may be a value determined by the higher layer of the UE. Accordingly, the UE may select candidate resources for S-PRS transmission in consideration of the priority of the S-PRS that the UE is to transmit and a priority of an S-PRS that another UE occupies or is to occupy. For example, if the S-PRS to be transmitted by the UE has a higher priority than the S-PRS to be transmitted by another UE, a probability that the UE selects a resource occupied by another UE may relatively increase.
The UE may randomly select resources for S-PRS transmission from among the N candidate resources selected based on the sensing result.
If sensing is not performed, resources for S-PRS transmission may be randomly selected from a candidate resource set available for selection.

Subsequently, in the embodiment, a scheme 2 operation method using a comb pattern of an S-PRS will be described. In other words, scheme 2 sensing may be performed based on a comb pattern of an S-PRS.

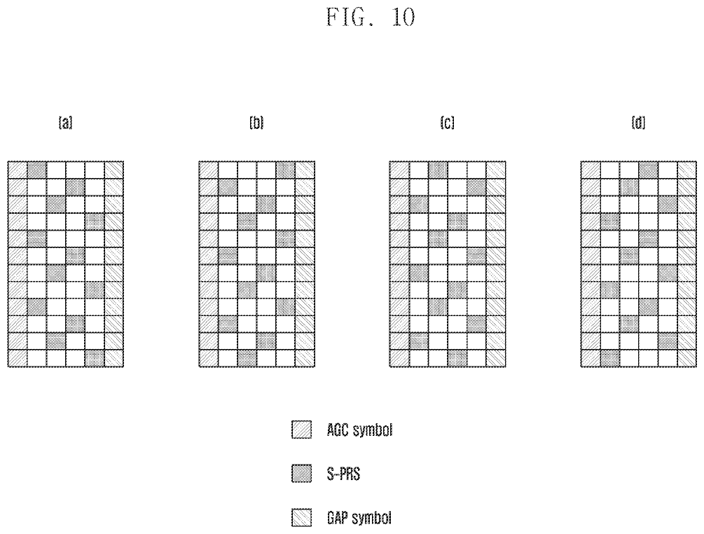

FIG. 10 is a diagram for describing scheme 2 sensing and resource selection operations based on a comb pattern of an S-PRS according to an embodiment of the disclosure.

Referring to FIG. 10, an example of a comb pattern of an S-PRS is illustrated.

For example, an S-PRS may be configured/mapped to a symbol between one AGC (automatic gain control) symbol and one GAP symbol. A comb pattern may be determined by a comb size and a comb offset. After sensing in units of subchannels is performed and final resources are selected, comb pattern-based scheme 2 sensing may be determined. For example, after sensing in units of subchannels is performed, a comb pattern may be determined. In this case, two methods may be considered as methods of determining a comb pattern. It is noted that the following two methods are merely illustrative in the disclosure, and the disclosure is not limited thereto. In addition, at least one of the following two methods may be supported, both the methods may be supported, or the two methods may be combined and used. When both of the following two methods are supported, one method may be (pre-)configured.
Method 1: In a selected subchannel, a comb size and a comb offset are randomly selected.
Method 2; In a selected subchannel, a comb size and a comb offset are selected via additional sensing.

In method 1, the comb size may be predetermined or preconfigured to be a specific value. In this case, only a comb offset value may be randomly selected, Conversely, the comb offset value may be predetermined or preconfigured, and the comb size may be randomly selected.

When IUC is used in method 1, a UE may randomly select one or more comb sizes and comb offsets, and provide another UE with comb size information and comb offset information for an S-PRS pattern corresponding to information 2 of the third embodiment.

Referring to FIGS. 10A to 10D, illustrated is an example of S-PRS patterns having different comb offsets when comb size=4. For example, FIGS. 10A, 10B, 10C, and 10D may correspond to cases in which comb offsets are 0, 1, 2, and 3, respectively. In addition, UEs that have received corresponding IUC information may multiplex S-PRSs based on comb patterns. For example, UE-A may transmit an S-PRS at a comb pattern position of FIG. 10A, UE-B may transmit an S-PRS at a comb pattern position of FIG. 10B, UE-C may transmit an S-PRS at a comb pattern position of FIG. 10C, and UE-D may transmit an S-PRS at a comb pattern position of FIG. 10D.

If a UE directly selects resources for S-PRS transmission instead of via IUC, the UE may randomly select one comb size and one comb offset, and transmit an S-PRS.

In method 2, the comb size may be predetermined or preconfigured to be a specific value. In this case, only a comb offset value may be determined via sensing.

Conversely, the comb offset value may be predetermined or preconfigured, and the comb size may be determined via sensing.

When IUC is used in method 2, a UE may determine one or more comb sizes and comb offsets, and provide another UE with comb size information and comb offset information for an S-PRS pattern corresponding to information 2 of the third embodiment.

Referring to FIGS. 10A to 10D, illustrated is an example of S-PRS patterns having different comb offsets when comb size=4. For example, FIGS. 10A, 10B, 10C, and 10D may correspond to cases in which comb offsets are 0, 1, 2, and 3, respectively. The UE may determine a pattern most suitable for S-PRS transmission among the comb patterns of FIGS. 10A to 10D via sensing and RSRP measurement at a comb pattern position. In addition, UEs that have received corresponding IUC information may multiplex S-PRSs based on comb patterns.

For example, UE-A may transmit an S-PRS at a comb pattern position of FIG. 10A, UE-B may transmit an S-PRS at a comb pattern position of FIG. 10B, UE-C may transmit an S-PRS at a comb pattern position of FIG. 10C, and UE-D may transmit an S-PRS at a comb pattern position of FIG. 10D.

If a UE directly selects resources for S-PRS transmission instead of via IUC, the UE may select one comb size and one comb offset via method 2, and transmit an S-PRS.

Subsequently, in the embodiment, a scheme 2 operation method using a time domain multiplexing (TDM) pattern of an S-PRS will be described. In other words, scheme 2 sensing may be performed based on a TDM pattern of an S-PRS.

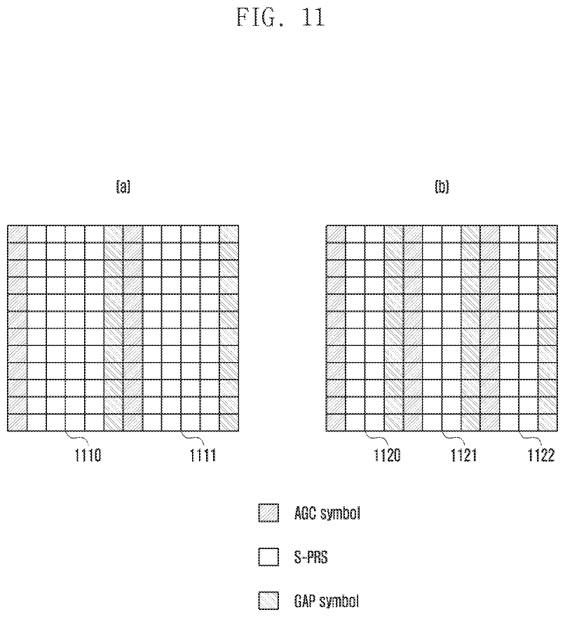

FIG. 11 is a diagram for describing scheme 2 sensing and resource selection operations based on a time domain multiplexing (TDM) pattern of an S-PRS according to an embodiment of the disclosure.

Referring to FIG. 11, an example of a TDM pattern of an S-PRS is illustrated. A TDM pattern may be determined by a scheme in which S-PRSs are TDMed in a sidelink slot. For example, FIG. 11 illustrates an example in which a position at which S-PRSs are TDMed in a sidelink slot is fixed. FIG. 11 illustrates at least a part of one sidelink slot or symbols included therein.

Referring to FIG. 11A, illustrated is a case in which there are two areas (1110 and 1111) in which S-PRSs may be TDMed in one slot. Referring to FIG. 11B, illustrated is a case in which there are three areas (1120, 1120, and 1121) in which S-PRSs may be TDMed in one slot. For example, the areas (1110, 1111, 1120, 1121, and 1122) in which S-PRSs may be TDMed may be configured/mapped to symbols between one AGC symbol and one GAP symbol. After sensing in units of subchannels is performed and final resources are selected, TDM pattern-based scheme 2 sensing may be determined. For example, after sensing in units of subchannels is performed, a TDM pattern may be determined. In this case, two methods may be considered as methods of determining a TDM pattern.

However, it is noted that the following two methods are merely illustrative in the disclosure, and the disclosure is not limited thereto. In addition, at least one of the following two methods may be supported, both the methods may be supported, or the two methods may be combined and used. When both of the following two methods are supported, one method may be (pre-)configured.
Method 1: In a selected subchannel, an area in which S-PRSs are transmitted is randomly selected.
Method 2: In a selected subchannel, an area in which S-PRSs are transmitted by considering TDM is selected via additional sensing.

When IUC is used in method 1, a UE may randomly select an area in which S-PRSs are transmitted in a slot, and provide another UE with time and frequency resource information for S-PRS transmission corresponding to information 1 of the third embodiment.

Referring to FIG. 11A, a case in which the area is 1110 or 1111 is illustrated. For example, 1110 or 1111 may be randomly selected. Referring to FIG. 11B, a case in which the area is 1120, 1121, or 1122 is illustrated. For example, referring to FIG. 11A, 1110 or 1111 may be randomly selected. Referring to FIG. 11B, 1120, 1121, or 1122 may be randomly selected. In addition, UEs that have received corresponding IUC information may multiplex S-PRSs based on TDM patterns.

For example, referring to FIG. 11A, UE-A may transmit S-PRSs at a position of 1110 of FIG. 11A, and UE-B may transmit S-PRSs at a position of 1111 of FIG. 11A. Referring to FIG. 11B, UE-A may transmit S-PRSs at a position of 1120 of FIG. 11B, and UE-B may transmit S-PRSs at a position of 1121 of FIG. 11B, In addition, UE-C may transmit S-PRSs at a position of 1122 of FIG. 11B.

If a UE directly selects resources for S-PRS transmission instead of via IUC, the UE may randomly select one position from the areas where S-PRSs may be transmitted in a slot, and may transmit S-PRSs.

When IUC is used in method 2, a UE may determine an area in which S-PRSs are transmitted in a slot, and provide another UE with time and frequency resource information for S-PRS transmission corresponding to information 1 of the third embodiment. The UE may determine, via sensing and RSRP measurement, whether an area is most suitable for S-PRS transmission among the areas in which S-PRSs are transmitted in a slot. For example, the UE may determine, via RSRP measurement of received S-PRSs, an area most suitable for S-PRS transmission in a slot. The UE may notify other UEs of information on the area via IUC information. In addition, UEs that have received corresponding IUC information may multiplex S-PRSs based on TDM patterns. For example, referring to FIG. 11A, UE-A may transmit S-PRSs at a position of 1010 of FIG. 11A, and UE-B may transmit S-PRSs at a position of 1011 of FIG. 11A. Referring to FIG. 11B, UE-A may transmit S-PRSs at a position of 1020 of FIG. 11B, and UE-B may transmit S-PRSs at a position of 1021 of FIG. 11B. In addition, UE-C may transmit S-PRSs at a position of 1022 of FIG. 11B.

If a UE directly selects resources for S-PRS transmission instead of via IUC, the UE may select, via method 2, one position from the areas where S-PRSs may be transmitted in a slot, and may transmit S-PRSs.

It is noted that the aforementioned scheme 2 operation using a comb pattern of an S-PRS and the aforementioned scheme 2 operation using a TDM pattern may be used in combination. In addition, for example, the aforementioned scheme 2 operation using a comb pattern and the aforementioned scheme 2 operation using a TDM pattern may be used only under the following condition(s). For example, when at least one of the following conditions is satisfied, the scheme 2 operation using a comb pattern or the scheme 2 operation using a TDM pattern, according to an embodiment, may be performed.
Condition 1: when absolute positioning is performed
Condition 2: when unicast or groupcast is performed
Condition 3: when positioning is performed in a resource pool defined for S-PRS (which may be referred to as a dedicated resource pool for SL positioning). When an S-PRS is transmitted in a resource pool for SL data transmission (which may be referred to as a shared resource pool with SL communication), only sensing in units of subchannels and slots may be performed.
Condition 4: when the scheme 2 operation using a comb pattern is configured
Condition 5: when the scheme 2 operation using a TDM pattern is configured
Condition 6: when a symbol length of a PRS and a comb pattern of an S-PRS are fixed and configured to one. This may be limited to the scheme 2 operation using a comb pattern of an S-PRS.

It is noted that, in the disclosure, the aforementioned conditions under which the scheme 2 operation using a comb pattern and the scheme 2 operation using a TDM pattern are performed are illustrative, and the disclosure is not limited only to the conditions. It is also noted that only some of the conditions may be applied.

Subsequently, operations of a UE having received IUC information for S-PRS transmission are proposed below. Operations of a UE having received IUC information may be classified into two. It is noted that the disclosure is not limited to the following two methods. For example, only one of the following methods may be supported. Alternatively, both the following methods may be supported, and a method to be used may be (pre-)configured or determined according to a specific condition.
Operation 1: An S-PRS is transmitted in S-PRS transmission resources according to received IUC information.
Operation 2: S-PRS transmission resources are determined by referring to received IUC information, and an S-PRS is transmitted.

Operation 1 is a method in which a UE having received IUC information transmits an S-PRS according thereto, and may be a method suitable for a UE that does not perform sensing for S-PRS transmission. This may also be a condition for performing operation 1. In contrast, operation 2 is a method in which a UE having received IUC information transmits an S-PRS according to the IUC information or transmits an S-PRS in resources other than those from the IUC information, and may be applied to a UE that performs sensing for S-PRS transmission. This may also be a condition for performing operation 2.

According to operation 2, a UE having received IUC information may determine resources for S-PRS transmission by using both of the IUC information and results of sensing and resource selection directly performed by the UE. For example, when the IUC information for S-PRS transmission is resource set information preferred for S-PRS transmission, the UE may select resources that form an intersection with a candidate resource set selected via direct sensing. When there is no resource forming an intersection, the following operations may be considered.
1) Follow IUC information.
2) Follow directly sensed information.
3) The UE determines one of 1) and 2).

In contrast, when the IUC information is non-preferred resource set information for S-PRS transmission, the UE may exclude the non-preferred resource set information indicated by the IUC information from a candidate resource set selected via direct sensing.

### Fifth Embodiment

The fifth embodiment proposes an S-PRS resource configuration method. For example, S-PRS resource configuration may be performed via configuration of a resource set and configuration of resources included in the resource set.

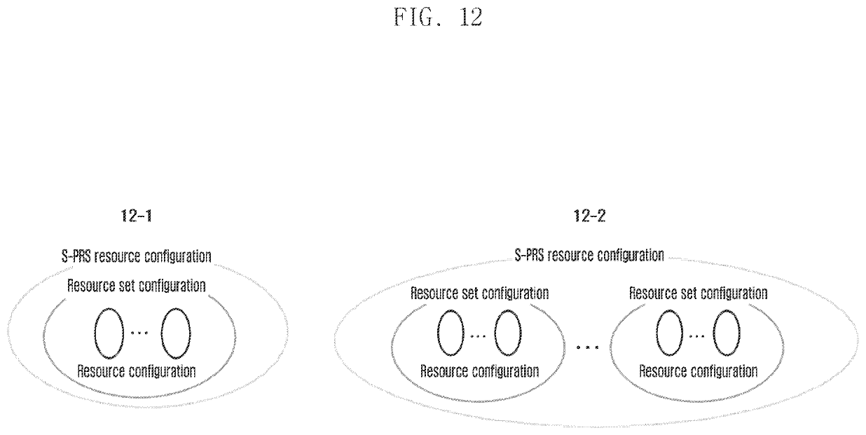

FIG. 12 is a diagram for describing an S-PRS resource configuration method according to an embodiment of the disclosure.

Referring to FIG. 12, sidelink positioning reference signal (S-PRS) resource configuration may include configuration of a resource set and configuration of resources included in the resource set. Up to X S-PRS resource configurations may be configured. Up to Y resource configurations included in each resource set may be configured. In the disclosure, values of X and Y are not limited to specific values.

Referring to FIG. 12-1, illustrated is a case in which a single resource set configuration is included in a single S-PRS resource configuration. For example, this configuration may be applied to a configuration corresponding to S-PRS transmission via periodic reservation.

Referring to FIG. 12-2, illustrated is a case in which multiple resource set configurations are included in a single S-PRS resource configuration. For example, this configuration may be applied to a configuration of S-PRS transmission that is not via periodic reservation. In addition, in the case of FIG. 12-2, the maximum number of resource set configurations which may be included in each S-PRS resource configuration may be S. In the disclosure, a value of S is not limited to a specific value.

The S-PRS transmission via periodic reservation may be a method of, when S-PRS resources are selected, reserving subsequent S-PRS transmission resources via a periodic reservation indication after a periodic reservation interval. For example, the periodic reservation may be continued until the operation is expired. The periodic reservation interval may be transmitted via SCI through a PSCCH. In contrast, S-PRS transmission that is not via periodic reservation may be a method of, without using periodic reservation, selecting resources to perform transmission every time when a UE transmits an S-PRS.

S-PRS information that may be included in the S-PRS resource set configuration may include one or more of the followings. It is noted that the following information is illustrative, and the disclosure is not limited only to the following information.
S-PRS resource set ID
Whether S-PRS transmission via periodic reservation is used. When periodic reservation is used, a periodic reservation interval may be transmitted via SCI through a PSCCH.
S-PRS starting symbol and symbol length (M) within a slot
Time offset (Toffset) from a reference slot: Here, the reference slot may be a reference point for determining a start position of an S-PRS
S-PRS starting sub-channel and its length (i.e., the number of sub-channels for SL PRS)
S-PRS repetition period (Nrep) and time gap (Tgap) between repetitions
S-PRS muting pattern
S-PRS max power
Latency bound for S-PRS transmission or measurement report

S-PRS information that may be included in the S-PRS resource configuration may include one or more of the followings. It is noted that the following information is illustrative, and the disclosure is not limited only to the following information.
S-PRS resource ID
S-PRS sequence ID
S-PRS comb size: The information may include one comb size and/or may include one or more candidate comb sizes.
SL PRS comb offset from a reference sub-carrier

The S-PRS resource set configuration and the S-PRS resource configuration may be (pre-)configured. In contrast, the information may be indicated via SLPP.

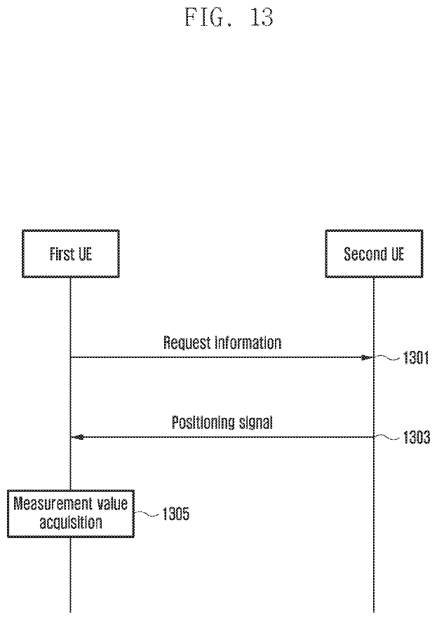

FIG. 13 is a diagram illustrating an example of operations of a first UE and a second UE according to an embodiment of the disclosure. The method of FIG. 13 is illustrative, and various modifications may be made to the method illustrated in the flowchart of FIG. 13. For example, although illustrated as a series of operations, various respective operations of the drawing may overlap, occur in parallel, occur in a different order, or occur multiple times. In another example, an operation may be omitted or replaced by another operation.

In operation 1301, a first UE may transmit request information to a second UE, and the second UE may receive the request information. For example, the request information may include request information for a positioning signal, but is not limited thereto.

In operation 1303, the second UE may transmit a positioning signal to the first UE, and the second UE may receive the positioning signal. For example, the positioning signal may be an S-PRS, but is not limited thereto. For example, resources in which the positioning signal is transmitted may be determined according to the embodiment of the disclosure. For example, for an entity that performs resource configuration for the positioning signal, reference may be made to the embodiment of the disclosure. For example, the resource configuration for the positioning signal may be performed by the first UE, the second UE, another UE, a base station, or a location server, but is not limited thereto.

In operation 1305, the first UE may acquire a measurement value based on the positioning signal. A type of the measurement value acquired by the first UE may vary depending on a positioning method configured for the first UE. For example, the first UE may report the measurement value, and for an entity that receives the reported measurement value, reference may be made to the embodiment of the disclosure. For example, the reported measurement value may be received by the second UE, another UE, a base station, or a location server, but is not limited thereto.

For more specific details of the respective operations illustrated in FIG. 13, reference may be made to the descriptions of the embodiment of the disclosure described above.

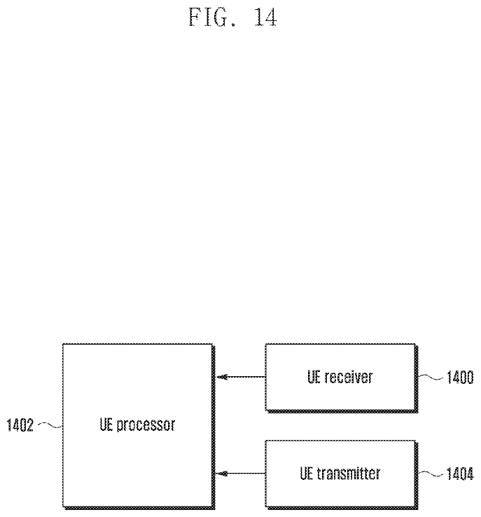

FIG. 14 illustrates a structure of a UE according to an embodiment of the disclosure.

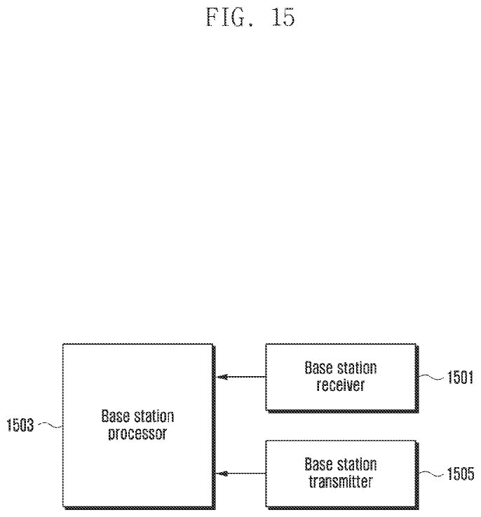

FIG. 15 illustrates a structure of a base station according to an embodiment of the disclosure.

Transmitters, receivers, and processors of the UE and the base station for performing the above embodiments of the disclosure are illustrated in FIG. 14 and

FIG. 15, respectively. Methods for performing positioning in a sidelink by the UE are provided in the above embodiments, and the transmitters, receivers, and processors the UE and the base station may be operated to perform the methods.

Specifically, FIG. 14 is a block diagram illustrating an internal structure of a UE according to an embodiment of the disclosure. As illustrated in FIG. 14, the UE of the disclosure may include a UE receiver 1400, a UE transmitter 1404, and a UE processor 1402. The UE receiver 1400 and the UE transmitter 1404 as a whole may be referred to as a transceiver. The transceiver may transmit/receive signals with base stations. The signals may include control information and data.

To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the UE processor 1402, and transmit signals output from the UE processor 1402 through the radio channel. The UE processor 1402 may control a series of procedures so that the UE can operate according to the above-described embodiments of the disclosure. The UE processor 1402 may include a processor.

FIG. 15 is a block diagram illustrating an internal structure of a base station according to an embodiment of the disclosure. As illustrated in FIG. 15, the base station of the disclosure may include a base station receiver 1501, a base station transmitter 1505, and a base station processor 1503. The base station receiver 1501 and the base station transmitter 1505 as a whole may be referred to as a transceiver. The transceiver may transmit/receive signals with UEs. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the base station processor 1503, and transmit signals output from the base station processor 1503 through the radio channel. The base station processor 1503 may control a series of processes so that the base station can operate according to the above-described embodiments of the disclosure. The base station processor 1503 may include a processor.

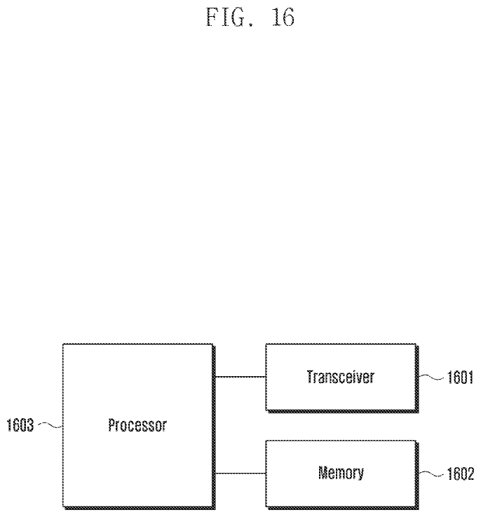

FIG. 16 illustrates a structure of a location server according to an embodiment of the disclosure.

Referring to FIG. 16, the location server may include a transceiver 1601, a memory 1602, and a processor 1603. The transceiver 1601 may communicate with one or more other devices connected thereto via one or more communication interfaces.

The memory 1602 may store control information or data included in signals acquired by the location server. The memory 1602 may be connected to the processor 1603 and may store one or more instructions or protocols or parameters that cause the location server to perform the operations according to an embodiment of the disclosure as described above. The processor 1602 may control a series of procedures so that the location server can operate according to the above-described embodiments. The operations of the location server may be performed by the processor 1603.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided.

The one or more programs stored in the computer-readable storage medium may be configured for execution by one or more processors within the electronic device.

The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, all the embodiment of the disclosure may be partially combined to operate a base station and a terminal.

1. A method performed by a terminal in a communication system, the method comprising:
identifying configuration information related to a sidelink positioning method;
transmitting sidelink control information (SCI);
in case that a sidelink positioning reference signal (SL-PRS) is requested based on a bit field included in the SCI:
receiving the SL-PRS; and
based on the SL-PRS, transmitting information on measurement corresponding to the sidelink positioning method; and
in case that measurement corresponding to the sidelink positioning method is requested based on the bit field included in the SCI,
transmitting the SL-PRS; and
after transmission of the SL-PRS, receiving information on measurement corresponding to the sidelink positioning method.

2. The method of claim 1, wherein, in case that a size of the bit field is 2 bits:
a first codepoint of the bit field indicates no-request for the SL-PRS and no-request for measurement corresponding to the sidelink positioning method;
a second codepoint of the bit field indicates a request for the SL-PRS;
a third codepoint of the bit field indicates a request for the SL-PRS and a request for measurement corresponding to the sidelink positioning method; and
a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

3. The method of claim 1, wherein, in case that a size of the bit field is 1 bit:
a first codepoint of the bit field indicates no-request for the SL-PRS and no-request for measurement corresponding to the sidelink positioning method; and
a second codepoint of the bit field indicates a request for the SL-PRS or indicates a request for the SL-PRS and a request for measurement corresponding to the sidelink positioning method, according to a type of the sidelink positioning method.

4. The method of claim 1, wherein, in case that information on a resource related to the received SL-PRS among resources included in a sidelink resource pool is transmitted, a resource of the received SL-PRS is based on the resource related to the SL-PRS, and
wherein the resource related to the received SL-PRS is a resource preferred by the terminal or a resource not preferred by the terminal.

5. A terminal in a communication system, the terminal comprising:
a transceiver; and
a processor connected to the transceiver,
wherein the processor is configured to:
identify configuration information related to a sidelink positioning method;
transmit sidelink control information (SCI);
in case that a sidelink positioning reference signal (SL-PRS) is requested based on a bit field included in the SCI:
receive the SL-PRS; and
based on the SL-PRS, transmit information on measurement corresponding to the sidelink positioning method; and
in case that measurement corresponding to the sidelink positioning method is requested based on the bit field included in the SCI:
transmit the SL-PRS; and
after transmission of the SL-PRS, receive information on measurement corresponding to the sidelink positioning method.

6. The terminal of claim 5, wherein, in case that a size of the bit field is 2 bits:
a first codepoint of the bit field indicates no-request for the SL-PRS and no-request for measurement corresponding to the sidelink positioning method;
a second codepoint of the bit field indicates a request for the SL-PRS;
a third codepoint of the bit field indicates a request for the SL-PRS and a request for measurement corresponding to the sidelink positioning method; and
a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

7. The terminal of claim 5, wherein, in case that a size of the bit field is 1 bit:
a first codepoint of the bit field indicates no-request for the SL-PRS and no-request for measurement corresponding to the sidelink positioning method; and
a second codepoint of the bit field indicates a request for the SL-PRS or indicates a request for the SL-PRS and a request for measurement corresponding to the sidelink positioning method, according to a type of the sidelink positioning method.

8. The terminal of claim 5, wherein, in case that information on a resource related to the received SL-PRS among resources included in a sidelink resource pool is transmitted, a resource of the received SL-PRS is based on the resource related to the SL-PRS, and
wherein the resource related to the received SL-PRS is a resource preferred by the terminal or a resource not preferred by the terminal.

9. A method performed by a terminal in a communication system, the method comprising:
identifying configuration information related to a sidelink positioning method;
receiving sidelink control information (SCI);
in case that a sidelink positioning reference signal (SL-PRS) is requested based on a bit field included in the SCI, transmitting the SL-PRS; and
in case that measurement corresponding to the sidelink positioning method is requested based on the bit field included in the SCI:
receiving the SL-PRS; and
based on the SL-PRS, transmitting information on measurement corresponding to the sidelink positioning method.

10. The method of claim 9, wherein, in case that a size of the bit field is 2 bits:
a first codepoint of the bit field indicates no-request for the SL-PRS and no-request for measurement corresponding to the sidelink positioning method;
a second codepoint of the bit field indicates a request for the SL-PRS;
a third codepoint of the bit field indicates a request for the SL-PRS and a request for measurement corresponding to the sidelink positioning method; and
a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

11. The method of claim 9, wherein, in case that a size of the bit field is 1 bit:
a first codepoint of the bit field indicates no-request for the SL-PRS and no-request for measurement corresponding to the sidelink positioning method; and
a second codepoint of the bit field indicates a request for the SL-PRS or indicates a request for the SL-PRS and a request for measurement corresponding to the sidelink positioning method, according to a type of the sidelink positioning method.

12. The method of claim 9, wherein, in case that information on a resource related to the received SL-PRS among resources included in a sidelink resource pool is transmitted, a resource of the received SL-PRS is based on the resource related to the SL-PRS, and
wherein the resource related to the received SL-PRS is a resource preferred by the terminal or a resource not preferred by the terminal.

13. A terminal in a communication system, the terminal comprising:
a transceiver; and
a processor connected to the transceiver,
wherein the processor is configured to:
identify configuration information related to a sidelink positioning method;
receive sidelink control information (SCI);
in case that a sidelink positioning reference signal (SL-PRS) is requested based on a bit field included in the SCI, transmit the SL-PRS; and
in case that measurement corresponding to the sidelink positioning method is requested based on the bit field included in the SCI:
receive the SL-PRS; and
based on the SL-PRS, transmit information on measurement corresponding to the sidelink positioning method.

14. The terminal of claim 13, wherein, in case that a size of the bit field is 2 bits:
a first codepoint of the bit field indicates no-request for the SL-PRS and no-request for measurement corresponding to the sidelink positioning method;
a second codepoint of the bit field indicates a request for the SL-PRS;
a third codepoint of the bit field indicates a request for the SL-PRS and a request for measurement corresponding to the sidelink positioning method; and
a fourth codepoint of the bit field (i) indicates a request for measurement corresponding to the sidelink positioning method or is reserved, according to a type of the sidelink positioning method, or (ii) indicates a request for measurement corresponding to the sidelink positioning method.

15. The terminal of claim 13, wherein, in case that a size of the bit field is 1 bit:
a first codepoint of the bit field indicates no-request for the SL-PRS and no-request for measurement corresponding to the sidelink positioning method; and
a second codepoint of the bit field indicates a request for the SL-PRS or indicates a request for the SL-PRS and a request for measurement corresponding to the sidelink positioning method, according to a type of the sidelink positioning method.
